(19) United States
(12) Patent Application Publication
(10) Pub. No.: US 2013/0139085 A1
(43) Pub. Date: May 30, 2013

(54) Operation Support Computer Program, Operation Support Computer System

(71) Applicant: Kenichi Ichino, Setagaya-ku (JP)

(72) Inventor: Kenichi Ichino, Setagaya-ku (JP)

(21) Appl. No.: 13/699,581

(22) PCT Filed: May 23, 2010
(86) PCT No.: PCT/JP2010/003457

§ 371 Date: Jan. 30, 2013

(30) Foreign Application Priority Data
Jun. 18, 2010 (FR) 1002580

(51) Int. Cl. G06F 3/0482

(52) U.S. Cl. CPC G06F 3/0482
USPC 715/767

(57) ABSTRACT

An operation-support computer program causes processing means to perform (1) assignment processing of first key input order information; (2) key input order information image display processing; (3) after assignment processing of the first key input order information has been performed, upon detecting a modification instruction of an object to be a focus of input, performing focus transition processing, performing deletion processing of the key input order information, carrying out update processing of the key input order information assignment, performing assignment processing of second key input order information and key input order information image display processing, and informing the user of the operation-support computer system of the relationships of the new key input orders; and (4) after assignment processing of the second key input order information has been performed, upon detecting a modification instruction of the object to be a focus of input, performing each of the processing of (3).

### CROSS-REFERENCE TO RELATED APPLICATION

This application claims the benefit of priority to International Patent Application PCT/JP2010/003457, filed on May 23, 2010, of which full contents are incorporated herein by reference.

### BACKGROUND OF THE INVENTION

1. Field of the Invention

The present invention relates to a computer program for supporting operations such as input by the system user in computer systems using such input device as a keyboard or mouse, especially to a technology for supporting operations when performing input-focus movement process to various objects such as a window of a software environment adopting multiple windows.

2. Description of the Related Art

A computer system with a GUI (Graphical User Interface) environment carries a multiple windows system in which multiple windows are displayed and multiple computer programs or data can be handled. In this multiple windows system, it is common that, in usual operating state, multiple windows are displayed and input device such as mouse is utilized to select each window.

But, in portable computers, that are widely used recently, such as mobile-phone, PDA, handheld gaming device, etc., number of press keys is limited in comparison with computers having a keyboard such as personal computer. Therefore, there is a difficulty in performing input-focus movement process to select a window to which operation is executed out of multiple windows on such computers having a limited number of press keys.

In addition, when view areas of each window overlapped, a window having a high priority is displayed on screen, but a window having a low priority is not displayed. Therefore, it is also very confusing, troublesome and inconvenient that a user of a computer with limited number of press keys selects a window having low priority in order to move an input focus.

View areas of various objects that are displayed on screen such as a toolbar, a typical example of window, frequently overlap each other. Thus, it is important for the user to effectively select existence or nonexistence of focus of object to be operated when using computers with limited number of press keys such as portable computer.

In the following patent documents 1 and 2, techniques relating to window operation in portable computers are described.

The following patent documents 1 and 2 include some techniques relating to window operation in portable computers that an inventor of present invention knows at the time of patent application.
Patent document 1: Japanese published unexamined application 2008-217130
Patent document 2: Japanese published unexamined application 2008-217131

### SUMMARY OF THE INVENTION

A problem to be solved by this invention is that how to provide a computer program or computer system that supports user's operation to move input-focus by using limited number of keys when a user operates a computer of which number of press keys is limited in a multiple window environment.

1

(1)

A computer program executed on a computer system where the computer system comprises a storage unit configured to store information, a processing unit configured to process information, an output unit configured to output information to a user, and an input unit configured to receive a command from a user, wherein the computer program is an operation-support computer program by which a plurality of objects are displayed on view area of the output unit, and by which the user is allowed to control an object out of the plurality of objects having an input focus through the input unit.

The storage unit is further configured to store the below relating to each other: an object id identifying the object, and an object view range indicative of a position/size of the object on the view area of the output unit, both of which are associated with each other; a press key sequence indicative of an identified press key of the input unit or a combination of the at least two identified press keys of the input unit, an allocating priority for the press key sequence to the objects id, both of which are associated with each other; the press key sequence, and an image of press key sequence that is an image indicative of the identified press key sequence of the input unit or a combination of the at least two identified press keys of the input unit, both of which are associated with each other.

The computer program, as the operation-support computer program, is configured to cause the processing unit to execute the steps of the following (1) to (4):

(1), as a first allocation process of press key sequence, for the object id identified by the object id stored in the storage unit out of the objects on the view areas of the output unit, calculating the first positional relation that is a relation between a first reference position of the output unit and the object view range associated with the object id in the storage unit, identifying association between the allocation priority for press key sequence and the press key sequence, on the basis of the calculated first positional relation, for the object id from the storage unit, performing an allocation process of press key sequence, that is, associating the identified press key sequence with the object id and storing an associated result in the storage unit,

(2), based on association between the press key sequence and the object id in the storage unit, and based on association between the press key sequence and the image of press key sequence in the storage unit, identifying the press key sequence associated with the object id in the storage unit, and identifying the image of press key sequence associated with the identified press key sequence, performing an image-display process of press key sequence, that is, displaying the identified image of press key sequence with reference to a view range of the output unit based on the object view range associated with the objet id, thereby notifying the user of the computer system of a press-key sequential relation, that is, which object to be reached by the input focus in response to a press of the identified press key of the input unit or a combined and consecutive press of the at least two identified press keys of the input unit, in a current display state of the output unit;

(3), when detecting a command to change the object to be targeted by the input focus in response to a press of the identified press key of the input unit by the user after the first allocation process of key sequence has been performed, performing an input-focus movement process, that is, identifying from the storage unit the object id associated with the press key sequence identical to the identified press key, and moving the input focus to the object indicated by the identified object id, out of the association between the press key sequence of the storage unit and the object id,

performing a deletion process of press key sequence, that is, deleting association of the object id with the press key sequence, whose head does not include the identified press key pressed by the user under a change command and which is identical to the identified press key pressed by the user under the change command out of association between the press key sequence and the object id in the storage unit,

identifying from the storage unit all the press key sequence whose head includes the identified press key pressed by the user under the change command, and which is constituted by combining the at least two identified press keys of the input unit,

for the each press key sequence, identifying the object id associated with said press key sequence, and deleting association therebetween from the storage unit,

performing an update process of press key sequence, that is, deleting from said each press key sequence the identified press key pressed by the user included in a head of said each press key sequence, thereby obtaining a new press key sequence and associating the new press key sequence with the object id having the association deleted therefrom, and storing an associated result in the storage unit,

as a second allocation process of press key sequence,

for the object id of the object having no input focus and not associated with press key sequence in the storage unit, out of the objects on the view area of output unit,

calculating a second position relation that is a relation between a second reference position of the output unit and the object view range associated with the object id in the storage unit,

identifying association between the allocation priority for press key sequence and the press key sequence, on the basis of the calculated second positional relation, for the object id from the storage unit,

performing an allocation process of press key sequence, that is, associating the identified press key sequence with the object id and storing an associated result in the storage unit,

performing an image-display process of press key sequence of the step of the (2), and notifying the user of the operation-support computer system of a new press-key sequential relation;

(4), when detecting a command to change the object to be targeted by the input focus in response to a press of the identified press key of the input unit by the use after the second allocation process of press key sequence has been performed, performing each process of the step of the (3).

(2)

Storage unit corresponds to a storage device in computer system such as RAM, ROM, HDD, etc.

Processing unit corresponds, for example, to an arithmetic logic unit such as CPU or to central processing server computer in computer system connected to communication network.

Output unit corresponds, for example, to an output unit that displays information in computer system such as a display, or to a portable phone terminal or personal computer as an information terminal in computer system connected to communication network.

Input unit corresponds, for example, to an input unit such as a keyboard, a mouse or a touch-panel in computer system or portable phone terminal or personal computer as an information terminal in computer system connected to communication network.

Operation-support computer system may be constructed within a single hardware such as personal computer, or may be constructed by multiple computers.

As an example case when it is constructed by multiple computers, there is a case in which processing unit is a central processing server computer, storage unit is a storage device controlled by the central processing server computer, output unit and input unit are information terminal (such as portable phone, personal computer) that communicate with the central processing server computer in a computer system connected to communication network.

View area of output unit is a displaying area for image or text data of output unit displaying information.

Input-focus is a term representing an object (window, etc.) to receive an input data at certain timing in multiple windows environment.

Object means a group of images displayed on view area of output unit by function of OS or applications. It corresponds, for example, to various windows, gadgets, icons, characters displayed by help function, etc.

As examples of various windows, there are a parent window (or main window to display mainly data of object of operation) and a child window (auxiliary window to make operation of toolbar or pallet window more easy), etc.

Object id is information consisting of numerical numbers or symbols to identify each object displayed on the view area of output unit. This object id is not required to be allocated to all the objects displayed on the view area of output unit, but is required to be allocated only to the objects that are possibly relating to the process of the present invention.

Object view range is information indicating a range (range of pixel) in which each object is displayed on the view area of output unit.

Press key sequence is information consisting of numerical numbers or symbols indicating an identified press key or a combination of the at least two identified press keys of the input unit, representing order of press keys (press key sequence) of the input unit.

Press key or key in the present invention corresponds to the input key in input unit such as key of keyboard or button of portable phone.

However, since input unit also includes mouse and touch-panel as above described, press key or key in the present invention is corresponds to something that becomes a trigger for receiving input command of input unit which includes a button of mouse and an input button displayed on touch-panel, and indicates.

“Identified press key” in the present invention means one press key out of multiple identified press keys featured on the input unit, and does not mean that the relevant “identified press key” is limited to one type of keys.

Similarly, “combination of the at least two identified press keys” in the present invention means a combination of 2 or more press keys out of multiple identified press keys, and does not mean that the relevant “combination of the at least two identified press keys” is limited to a series of one type of keys.

“allocation priority for press key sequence” is information consisting of numerical numbers or symbols that represent the priority ranking for allocating the object id for each of the press key sequence

“image of press key sequence” is image information that represents a picture for an identified press key or the order of the at least two identified press keys combination.

“the object id stored in the storage unit out of the objects on the view areas of the output unit” describes an object on which object id to be a target of process is allocated, since object ids are not necessarily allocated to all objects on the view area of output unit.

“for the object id” does not mean “for all objects to which object id is allocated”, however it indicates that a targeted object is one of the objects to which object id is allocated.

In addition, “for the object id” does not mean that one process is performed for one object id, but there is a case that more than one processes are performed for one object id.

“first reference position of the output unit” is a position that becomes a base on the view range of the output unit. It is not necessarily that the reference position is always fixed. There is a case that it is determined out of multiple candidate positions as described later.

“first positional relation” is a positional relation between the first reference position of the output unit and the object view range on the output unit. As examples of the “first positional relation”, there are various calculation methods such as; to consider only X-axis positional relation, to consider only Y-axis positional relation, to consider X- and Y-axis positional relation, and to multiply a constant coefficient to positional relation of X- and Y-axis.

“identifying association between the allocation priority for press key sequence and the press key sequence, on the basis of the calculated first positional relation, for the object id from the storage unit” means to identify the allocation priority for the press key sequence and press key sequence by comparing the numerical number calculated of the first positional relation for the relevant object id.

“Identify” means to try to identify, and there are both cases that it is possible and not possible to identify.

“an allocation process of press key sequence, that is, associating the identified press key sequence with the object id and storing an associated result in the storage unit” is a process that associates one press key sequence to one object id. Therefore, when allocation process of press key sequence was applied to one object id by more than one time, it may occurs that multiple press key sequence are associated to one object id.

As example of termination condition of “the first allocation process for press key sequence”, such cases can be thought as; for the object id of objects other than the object having an input-focus, at least one allocation process of press key sequence is performed, certain times of allocation process for press key sequence are performed, it reaches to a state that any further allocation process for press key sequence cannot be performed, or at least one time of allocation process for press key sequence has been performed for all the object ids.

As an example of “image-display process of press key sequence, that is, displaying the identified image of press key sequence with reference to a view range of the output unit based on the object view range associated with the objet id” is to display image of press key sequence at the fixed position within or out of the object view range of the output unit.

Press key sequences information representing a relation of an identified press key of the input unit or a combination of the at least two identified press keys of the input unit and an object to which the input-focus is moved to as a result,

“deleting association of the object id with the press key sequence, whose head does not include the identified press key pressed by the user under a change command and which is identical to the identified press key pressed by the user under the change command out of association between the press key sequence and the object id in the storage unit” means to delete allocation of press key sequence when it matches completely or its head does not match with an identified key pressed by the user at the change command.

“[press key sequence] which is constituted by combining the at least two identified press keys of the input unit” is the press key sequence consisting of a combination of the at least two identified press keys of the input unit.

“deleting from said each press key sequence the identified press key pressed by the user included in a head of said each press key sequence, thereby obtaining a new press key sequence” means to remove the identified press key pressed by the user which is at the head of the press key sequence, and regard the press key sequence from which the head of the press key sequence was removed to be a new press key sequence.

“for the object id of the object having no input-focus and not associated with press key sequence in the storage unit, out of the objects on the view area of output unit” means an object that has no input-focus is not included in the targets of allocation process of press key sequence since the input-focus does not move to the object with no input focus, but it does not exclude the allocation process to the object having an input focus.

Similarly, “for the object id of the object having no input-focus and not associated with press key sequence in the storage unit, out of the objects on the view area of output unit” indicates that object id associated with the press key sequence is not included in the target of allocation process of press key sequence since it is not necessarily, but this does not exclude the allocation process of press key sequence to an object id which does not associate with press key sequence.

That is, “for the object id of the object having no input-focus and not associated with press key sequence in the storage unit, out of the objects on the view area of output unit” indicates to perform the allocation process of press key sequence for object id that has no input-focus and is not associated to the press key sequence.

The second reference position of the output unit indicates a position that becomes a base on the view range of the output unit. It is not necessarily that the reference position is always fixed. There is a case that it is determined out of multiple candidate positions as described later.

Second positional relation is a positional relation between the second reference position of the output unit and the object view range of the output unit. As examples of second positional relation, there are various calculation methods such as; to consider only positional relation of X-axis, to consider only positional relation of Y-axis, to consider positional relation of X- and Y-axis, and to multiply a constant coefficient to positional relation of X- and Y-axis.

“Identifying association between the allocation priority for press key sequence and the press key sequence, on the basis of the calculated second positional relation, for the object id from the storage unit” means to identify the allocation priority for the press key sequence and press key sequence by comparing the numerical number calculated of the second positional relation for the relevant object id.

As example of termination condition of “the second allocation for press key sequence”, such cases can be thought as; for the object id of objects other than the object having an input-focus, at least one allocation process of press key sequence is performed, certain times of allocation process for press key sequence are performed, it reaches to a state that any further allocation process for press key sequence cannot be performed, or at least one time of allocation process for press key sequence has been performed for all the object ids.

“Performing each process of the step of the (3)” means to perform again all the processes of step (3), input-focus movement process, deleting press key sequence, updating process of allocation of press key sequence, second allocating process of press key sequence, and image-display process of press key sequence of step (2).

(3)

In the present invention, press key sequence and object id are associated by the first allocation process of press key sequence, and this association is displayed to the user of the computer system by image-display process of press key sequence.

After the first allocation process of press key sequence, when detecting a command to change the object to be targeted by the input-focus, the association between the press key sequence and object id are corrected through the input-focus movement process, the deleting press key sequence, the updating process of allocation of press key sequence, the second allocating process of press key sequence, and the image-display process of press key sequence, and the result is displayed to the user.

Further, after the second allocation process of press key sequence, when detecting a command to change the object to be targeted by the input-focus, the association between press key sequence and object id is corrected in the same way and the result is displayed to the user.

Thereby, the operation support for input-focus movement by limited numbers of press keys becomes possible when the user operates computer with limited number of press keys in the multiple window system.

This enables to associate between the object id and the press key sequence utilizing association between the press key sequence and allocation priority of press key sequence based on the first or the second positional relation without having user's any special awareness to such operation.

2

(1)

In other invention, the computer program, as the operation-support computer program, is configured to cause the processing unit to execute the steps of the following (1) to (4) in addition to the said structure and the process (1), (2) and (4).

(3), when detecting a command to change the object to be targeted by the input focus in response to a press of the identified press key of the input unit by the user after the first allocation process of press key sequence has been performed,

performing an input-focus movement process, that is, identifying from the storage unit the object id associated with the press key sequence identical to the identified press key, and moving the input focus to the object indicated by the identified object id,

identifying all the press key sequence whose head includes the identified press key pressed by the user under the change command and which is constituted by combining the at least two identified press keys of the input unit from the storage unit

for said each press key sequence,

performing an updating allocation process of press key sequence, that is, deleting the said identified press key pressed by the user included in a head of said each press key sequence from said each press key sequence, thereby obtaining a new press key sequence and associating the new press key sequence with the object id having had the association therefrom, and storing an associated result again in the storage unit,

renewing association between press key sequence and the object id to the latest association between press key sequence and the object id after the update process

as a second allocation process of press key sequence,

for the object id of the object having no input focus and not associated with press key sequence in the storage unit, out of the objects on the view area of output unit,

calculating a second position relation that is a relation between a second reference position of the output unit and the object view range associated with the object id in the storage unit,

identifying association between the allocation priority for press key sequence and the press key sequence, on the basis of the calculated second positional relation, for the object id in the storage unit,

performing an allocation process of press key sequence, that is, associating the identified press key sequence with the object id and storing an associated result in the storage unit,

performing an image-display process of press key sequence of the step of the (2), and notifying the user of the operation-support computer system of a new press-key sequential relation;

(5) after the second allocation process of press key sequence, regarding the association between press key sequence and object id of one generation before the update of allocation process of press key sequence in step (3) to be the latest association between press key sequence and object id, when detecting a return command of press key sequence in response to a press of the identified press key of the input unit by the user,

performing an input-focus movement process, that is, moving back the input focus to the object that had an input focus before an input-focus movement process at the step of the (3),

(2)

“renewing association between press key sequence and the object id to the latest association between press key sequence and the object id after the update process” means to perform generation management holding association between the press key sequence of the storage unit before updating the allocation process of press key sequence and object id in the storage unit, and takes association between press key sequence after the updating process and object id to be targeted of succeeding processing.

“return command of press key sequence” is a command to change the association between the press key sequence of storage unit and the object id to be the association of one generation before, that is, the association before the update process of the allocation of press key sequence.

The state of input-focus and the press key sequence allocation are returned to that of before the process of step (3) by “regarding the association between press key sequence and object id of one generation before the update of allocation process of press key sequence in step (3) to be the latest association between press key sequence and object id” and “moving back the input-focus to an object that had an input-focus, prior to focus movement process in the step (3)”.

(3)

In the present invention, the press key sequence and the object id are associated by a first allocation process of press key sequence, and this association is displayed to the user of the computer system by image-display process of press key sequence.

when detecting a command to change the object to be targeted by the input-focus, after the first allocation process of press key sequence, association between the press key sequence and the object id are corrected through input-focus movement process by deleting the press key sequence, updating process of the allocation of press key sequence, second allocating process of press key sequence, and image-display process of press key sequence, and displays the result to the user.

Further, after the second allocation process of for press key sequence has been performed, when detecting a command to change the object to be targeted by the input-focus, association between press key sequence and object id is corrected and displays the result to the user in the same way.

after the second allocation process of press key sequence, regarding the association between the press key sequence and the object id of one generation before the update of allocation process of press key sequence to be the latest association between press key sequence and object id, when detecting a return command of press key sequence and moving back the input focus to the object that had an input focus before an input-focus movement process

Thereby, operation support for input-focus movement by limited numbers of press keys becomes possible when a user operates computer with limited number of press keys in the multiple windows system.

This enables to associate between object id and press key sequence utilizing association between press key sequence and allocation priority of press key sequence based on the first or the second positional relation without user's any special awareness to such operation.

Especially when a user of computer system request, it is possible to perform the process taking the association between the press key sequence and the object id of one generation before the update of allocation process of press key sequence to be the latest association.

3

(1)

In other invention, there is an operation-support computer program, wherein, adding to the said structure and the process, the first reference position of the output unit at the first allocation process of press key sequence is determined with reference to the view area of an object having an input focus, a mouse cursor, or an input cursor, which are displayed on the view area of the output unit, and the second reference position of the output unit at the second allocation process of press key sequence is determined with reference to the view area of an object having an input-focus displayed on the view area of the output unit.

(2)

As an example of “determined with reference to the view area of an object having an input-focus, a mouse cursor, or an input cursor, which are displayed on the view area of the output unit” is to choose one of the object having an input focus, a mouse cursor, or an input cursor as a reference, or choose the one of the view are of objects with the highest priority targeted by the priority allocation process.

(3)

In the present invention, the first reference position of the output unit at the first allocation process of press key sequence is determined with reference to the view area of an object having an input-focus, a mouse cursor, or an input cursor, which are displayed on the view area of the output unit,

the second reference position of the output unit at the second allocation process of press key sequence is determined with reference to the view area of an object having an input-focus displayed on the view area of the output unit.

Thereby, the first reference position and the second reference position are determined with reference to the view area of an object having an input-focus, mouse cursor, an input cursor, this enables to perform allocation process for press key sequence wherein, press key sequence may be smoothly moved from these reference positions.

4

(1)

In other invention, there is an operation-support computer program, wherein, adding to the said structure and the process,

the first reference position of the output unit at the first allocation process of press key sequence is determined with reference to a view area of an object having the highest priority on the view area of the output unit indicated by an object id to be target of the first allocation process of press key sequence, out of displayed objects on the view area of the output unit, that is, an object having an input focus, a mouse cursor, an input cursor, and an object to which allocation process of press key sequence has already been applied,

and for the allocation process of press key sequence of a combination of the at least two identified press keys of the input unit,

when plurality of object ids are reference to the same object as the first reference position, for the object id with the highest priority in the first positional relation

performing the allocation process of press key sequence that associates between the object id and the identified press key sequence, which is one added identified press key sequence to the press key sequence allocated to the object of the first reference position, and which is the highest in the allocation priority in the press key sequence in the storage unit and not yet allocated to any object, repeating the allocation process of the press key sequence until the first termination condition is satisfied after adding objects performed the allocation process of the press key sequence to the first reference position, and

performing the first allocation process of press key sequence,

wherein the second reference position of the output unit at the second allocation process of key sequence is, out of an object having an input-focus, and an object to which allocation process of press key sequence has already been applied,

determined with reference to a view area of an object having the highest priority on the view area of the output unit on the view area of the output unit indicated by an object id to be targeted by an object of the second allocation process of press key sequence and

the allocation process of press key sequence of a combination of the at least two identified press keys of the input unit is performing the first allocation process of press key sequence as follows,

when plurality of object ids are reference to the same object as the second reference position, for an object id with the highest priority in the second positional relation

performing the allocation process of press key sequence that associates between the object id and the identified press key sequence, which is one added identified press key sequence to the press key sequence allocated to the object of the first reference position, and which is the highest in the allocation priority in the press key sequence in the storage unit and not yet allocated to any object

adds the object that the allocation process of press key sequence is applied to the second reference position until the second termination condition is satisfied and repeats the allocation process of press key sequence, and performs the second allocation process of press key sequence.

(2)

“view area of an object having the highest priority” in “view area of an object having the highest priority as a reference in the view area in the output unit of an object that is indicated by an object id that becomes an object of the first allocation process of press key sequence” is judged based on priority standard of the first reference position defined by operation-support computer program, such as the nearest view area to “view area of an object having the highest priority as a reference in the output unit of an object that is indicated by an object id that becomes an object of the first allocation process of press key sequence” (by considering only X-axis positional relation, considering only Y-axis positional relation, considering X- and Y-axis positional relation, and to multiply a constant coefficient to positional relation of X- and Y-axis, etc.) or judgment based on fixed priority in case there are multiple candidates of first reference position (for example, the first priority is given to an object to which allocation process of press key sequence has already been applied, the second priority is given to an object having an input-focus, the third priority is given to mouse cursor or input cursor are the third priority, and when there are multiple objects having the same priority, the higher the priority is given to the nearer the positional relation, etc.)

“view area of an object having the highest priority” in “view area of an object having the highest priority as a reference in the view area in the output unit of an object that is indicated by an object id that becomes an object of the second allocation process of press key sequence” indicates the same as above.

“about the allocation process of press key sequence of press key sequence indicating at least two identified press keys combination” does not include that press key sequence consisting of only one identified press key and only indicates the allocation process of press key sequence consisting of a combination of the at least two identified press keys.

However, it does not exclude the same process as “about the allocation process of press key sequence of press key sequence indicating combination of the at least two identified press keys” for the press key sequence consisting of only one identified press key.

“plurality of object ids are reference to the same first reference position” indicates plural of object ids which are target of the allocation process of the press key sequence are reference with the same first reference position at the first location relation, such as an object with input-focus, a mouse cursor, an input cursor, or an object, to which allocation process of press key sequence has already been applied

“an object id with the highest priority in the first positional relation” in “when plurality of object ids are reference to the same first reference position, for an object id with the highest priority in the first positional relation” is judged based on priority standard of the first reference position defined by operation-support computer program, such as the nearest view area to the first positional relation (by considering only X-axis positional relation, considering only Y-axis positional relation, considering X- or Y-axis positional relation, and multiplying a constant coefficient to positional relation of X- and Y-axis, etc.) or judgment based on fixed priority in case there are multiple candidates of first reference position (for example, the first priority is given to an object to which allocation process of press key sequence has already been applied, the second priority is given to an object having an input-focus, the third priority is given to mouse cursor or input cursor, and when there are multiple objects having the same priority, the higher the priority is given to the nearer the positional relation, etc.).

“For an object id with the highest priority in the second positional relation” in “when plurality of object ids are reference to the same second reference position, for an object id with the highest priority in the second positional relation” indicates the same as above.

“One added identified press key sequence to the press key sequence allocated to the object of the first reference position” indicates the press key sequence that is added one press key to the press key sequence indicated by press key sequence allocated to an object id of object as a source of the first reference position.

“Identified press key sequence . . . which is the highest in the allocation priority in the press key sequence in the storage unit and not yet allocated to any object” means to identify a press key sequence associated with the highest allocation priority out of the press key sequences which allocation process of press key sequence have not yet been applied to and have not been associated with object.

Examples of “until first termination condition is satisfied” might be, for the object id of the object other than that having an input-focus, until at least one allocation process for press key sequence is performed, until certain times of allocation process for press key sequence are performed, until it reaches to a state that any further allocation process for press key sequence cannot be performed, or until at least one time of allocation process for press key sequence has been performed for all the object ids.

“second termination condition is satisfied” has the same meaning as “first termination condition is satisfied”, but it is not required to be the same. The first and the second termination condition may satisfy either the same or different condition.

“repeating the allocation process of the press key sequence until the first termination condition is satisfied after adding objects performed the allocation process of the press key sequence to the first reference position” means to repeat the allocation process of press key sequence until the first termination condition is satisfied while adding the object to which allocation process of press key sequence has already been applied as a candidate of the first reference position of the output unit.

“when plurality of object ids are reference to the same object as the second reference position, for an object id with the highest priority in the second positional relation” indicates plural of object ids which are target of the allocation process of the press key sequence are reference with the same second reference position at the second location relation, such as an object with input-focus, a mouse cursor, an input cursor, or an object, to which allocation process of press key sequence has already been applied.

“one added identified press key sequence to the press key sequence allocated to the object of the second reference position” means an press key sequence that is added one press key to the press key sequence indicated by the press key sequence allocated to an object id of object as a source of the second reference position.

(3)

In the present invention, the first reference position of the output unit at the first allocation process of press key sequence is determined with reference to the view area of an object having the highest priority on the view area of the output unit indicated by an object id targeted to be an object of the first allocation process of press key sequence out of displayed objects on the view area of the output unit, that is, an object having an input focus, a mouse cursor, an input cursor, and an object to which allocation process of press key sequence has already been applied,

the second reference position of the output unit at the second allocation process of press key sequence is determined having the highest priority on the view area of the output unit indicated by an object id to be targeted to be an object of the second allocation process of press key sequence out of displayed objects on the view area of the output unit, that is, object having an input-focus, object an object to which allocation process of press key sequence has already been applied.

and for the allocation process of press key sequence of a combination of the at least two identified press keys of the input unit, when plurality of object ids are reference to the same object as the first or second

reference position, for an object id with the highest priority in the first or second positional relation

performing the allocation process of press key sequence that associates between the object id and the identified press key sequence, which is one added identified press key sequence to the press key sequence allocated to the object of the first or second reference position, and which is the highest in the allocation priority in the press key sequence in the storage unit and not yet allocated to any object.

repeating the allocation process of the press key sequence until the first or the second termination condition is satisfied after adding objects on which the allocation process of the press key sequence performed to the first or the second reference position.

Thereby, the first reference position and the second reference position are determined with reference to the view area of an object having an input-focus, mouse cursor, an input cursor, this enables to perform allocation process for press key wherein press key sequence may be smoothly moved from these reference positions.

and for the allocation process of press key sequence of a combination of the at least two identified press keys of the input unit, the characteristic allocation process of the press key sequence enables to change the press key sequence smoothly between objects.

5

(1)

In other invention, there is an operation-support computer program, wherein, the first reference position of the output unit at the first allocation process of press key sequence

is determined with reference to the view area of an object having an input focus, a mouse cursor, an input cursor, or an object to which allocation process of press key sequence has already been applied,

for the first positional relation calculating a combination between the first reference position and the object id of the storage unit,

and the allocation process of press key sequence of a combination of the at least two identified press keys of the input unit,

identifying the press key sequence having the highest priority from the storage unit of which press key sequences has one added identified press key to the press key sequence allocated to the reference object of the first reference position and not yet performed the allocation process of the input key sequence and,

for the first reference position, performing the allocation process of key sequence, that is, associating the identified press key sequence and an object id, with reference to the first positional relation calculated from the combination of the first reference position and the object id, and storing an associated result in the storage unit,

determining a new first reference position with reference to the view area of the object to which the allocation process of press key sequence was applied in adjacent process and repeating the allocation process of the press key sequence until the first termination condition is satisfied,

the second reference position of the output unit at the second allocation process of press key sequence is determined with reference to the view range of the displayed object to which allocation process of press key sequence has already been applied and an displayed object having an input focus on the view area,

calculating a combination between the second reference position and the object id of the storage unit for the second positional relation, and

for the allocation process of press key sequence of a combination of the at least two identified press keys of the input unit

identifying the press key sequence having the highest priority from the storage unit of which press key sequences having one added identified press key to the press key sequence allocated to the reference object of the second reference position and not yet performed the allocation process of the input key sequence and,

for the second reference position, performing the allocation process of key sequence, that is, associating the identified press key sequence and the object id, with reference to the second positional relation calculated from the combination of the second reference position and the object id, and storing an associated result in the storage unit,

determining a new second reference position with reference to the view area of the object to which the process of allocation for key input sequence was applied in adjacent process and repeating the allocation process of the press key sequence until the second termination condition is satisfied.

(2)

“for the first reference position, performing the allocation process of key sequence” means to perform the allocation process of press key sequence, which is one added identified press key sequence to the press key sequence allocated to the object of the first reference position, after identifying the press key sequence with the highest priority in the allocation priority in the storage unit and not yet allocated to any object

“for the first reference position, performing the allocation process of key sequence” does not mean to perform the allocation process only once but there is also a case that multiple times of processes are performed.

Similarly, “for the second reference position, performing the allocation process of key sequence” means to perform the allocation process of press key sequence, which is one added identified press key sequence to the press key sequence allocated to the object of the second reference position, after identifying the press key sequence with the highest priority in the allocation priority in the storage unit and not yet allocated to any object

“for the second reference position, performing the allocation process of key sequence” does not mean to perform the allocation process only once but there is also a case that multiple times of processes are performed.

“determining a new first reference position with reference to the view area of the object to which the process of allocation for press key sequence was applied in adjacent process and repeating the allocation process of the press key sequence until the first termination condition is satisfied”

means to repeat the allocation process of the press key sequence until the first termination condition is satisfied, even when multiple of allocation processes perform on one object id as a result of the definition of a new first reference location in reference with the view area of an object to which the allocation process of the press key sequence applied in the adjacent process.

Similarly, “determining a new second reference position with reference to the view area of the object to which the process of allocation for key input sequence was applied in adjacent process and repeating the allocation process of the press key sequence until the second termination condition is satisfied” means to repeat the allocation process of the press key sequence until the first termination condition is satisfied, even when multiple processes of allocation process perform on one object id as a result of the definition of a new first reference location in reference with the view area of an object to which the allocation process of the press key sequence applied in the adjacent process.

(3)

In the present invention, first reference position of the output unit at the first allocation process of press key sequence is determined with reference to the view area of an object having an input-focus, a mouse cursor, or an input cursor, which are displayed on the view area of the output unit

the second reference position of the output unit at the second allocation process of press key sequence is determined with reference to the view range of the displayed object to which allocation process of press key sequence has already been applied and an displayed object having an input focus on the view area of the output unit.

Further, the first or the second positional relation is calculated combination of the first or the second reference position and object id of storage unit.

and for the allocation process of press key sequence of a combination of the at least two identified press keys of the input unit

identifying press key sequence, which is one added identified press key sequence to the press key sequence allocated to the object of the first or second reference position, and which is the highest in the allocation priority in the press key sequence in the storage unit and not yet allocated to any object

for the first or second reference position, performing the allocation process of key sequence, that is, associating the identified press key sequence with the object id, with reference to the first or second positional relation, calculated from the combination of the first or second reference position and the object id, and storing an associated result in the storage unit,

determining a new first or second reference position with reference to the view area of the object to which the process of allocation for press key sequence was applied in adjacent process and repeating the allocation process of the press key sequence until the first or second termination condition is satisfied.

Thereby, the first reference position and the second reference position are determined with reference to the view area of an object having an input-focus, mouse cursor, an input cursor, and an object to which allocation process of press key sequence has already been applied, this enables to perform allocation process for press key sequence wherein, press key sequence may be smoothly moved from these reference positions.

Especially, for the allocation process of press key sequence, which a combination between the first or second reference position and the object id of the storage unit is calculated in and a combination of the at least two identified press keys of the input unit represents, enables for press key sequence change smoothly among objects because of the characteristic allocation process.

Further, determining a new first or second reference position with reference to the view area of the object to which the allocation process for press key sequence was applied in adjacent process and repeating the allocation process of the press key sequence until the first or second termination condition is satisfied. This may allocate plural of press key sequences to an object, which enables press key sequence change smoothly among objects.

6

(1)

In the other invention of the computer program is an operation-support computer program, as an image-display process of press key sequence, when the identified object id is associated with plurality of press key sequences, identifying a press key sequence with a highest priority out of plurality of objects on the basis of the allocation priority and displaying the image of press key sequence associated with the said identified press key sequence on the output unit.

(2)

“when the identified object id is associated with plurality of press key sequences” means that, when the input-focus moves to an identified object in which case multiple (two or more) press key sequences associate with the identified object id, there are multiple methods of press key sequence.

“identifying a press key sequence with a highest priority out of plurality of objects on the basis of the allocation priority and displaying the image of press key sequence associated with the said identified press key sequence on the output unit in which case multiple (two or more) press key sequences associate with the identified object id, display the image of the press key sequences with the highest priority on the output unit in accordance with the allocation priority of the press key sequence in order to present the image of the press key sequence with the highest priority to the user.

(3)

In the present invention, as an image-display process of press key sequence, identifying a press key sequence with a highest priority out of plurality of objects on the basis of the allocation priority and displaying the image of press key sequence associated with the said identified press key sequence on the output unit, when the identified object id is associated with plurality of press key sequences.

Thereby, when the identified object id is associated with plurality of press key sequences, displaying the image of the press key sequence with the press key sequence which has the highest priority in the allocation priority on the output unit. This enables to present the image of the press key sequence of which press key sequence changes smoothly among objects.

7

(1)

In other invention, there is an operation-support computer program, wherein, the storage unit is further configured to:

store a press key sequence indicative of an identified press key of the input unit or a combination of the at least two identified press keys of the input unit, and allocating priority for press key sequence to the objects id, both of which are associated with each other according to an allocation priority rule defining priorities between identified press keys of the input unit,

store the identified input key id of the input unit and the input key allocation priority indicative of allocation priority between the input keys in the input unit, both of which are associated with each other,

perform a creation process of press key sequence that associates the allocation priority for press key sequence and the press key sequence wherein the allocation priority rule defining priorities between identified press keys of the input unit indicative of the association between allocating priority for press key sequence and the objects id stored in the storage unit, and storing an associated result in the storage unit and

therefore creates an association between allocation priority of press key sequence of the storage unit and the press key sequence.

(2)

“identified press key id of the input unit” is information consisting of numerical numbers or symbols of the input unit.

“allocation priority rule” is information that defines allocation priority relation between identified press keys of the input unit. By this allocation priority rule, “press key sequence” and “allocation priority of press key sequence” are associated to each other. That is, the association between “press key sequence” and “allocation priority of press key sequence” is regulated by priority relation between the identified keys of the input unit.

“allocation priority of press key” is information consisting of numerical numbers and symbols indicating allocation priority between the identified press keys.

“a creation process of press key sequence that associates the allocation priority for press key sequence and the press key sequence wherein the allocation priority rule defining priorities allocated to identified press keys of the input unit indicative of the association between allocating priority for press key sequence and the objects id stored in the storage unit and storing an associated result in the storage unit” indicates the process to create association between allocation priority of press key sequence and press key sequence so as not to violate priority relation determined by association between press key allocation priority and press key id and stores the associated result in the storage unit.

(3)

The present invention performs a creation process of press key sequence that associates the allocation priority for press key sequence and the press key sequence wherein the allocation priority rule defining priorities between identified press keys of the input unit indicative of the association between allocating priority for press key sequence and the objects id stored in the storage unit and storing an associated result in the storage unit and

associate between allocation priority of press key sequence of the storage unit and the press key sequence.

Thereby, it is possible to automatically create the association between the allocation priority of press key sequence and the press key sequence that is consistent with the allocation priority rule that defines the allocation priority relation between the press keys of the input unit by storing the identified press key id of the input unit and press key allocation priority indicating allocation priority between the identified press keys of the input unit associating them each other.

8

(1)

In other invention, there is an operation-support computer program, wherein,

when either a first reference position of the output unit at the first allocation process of key sequence or the object id in the storage unit on the view area of the output unit changes and,

after the first allocation process of key sequence has been performed,

when either a first reference position of the output unit at the first allocation process of key sequence or the object view range on the view area of the output unit

indicated by the object id in the storage unit changes and,

after the second allocation process of key sequence has been performed,

when either a second reference position of the output unit at the second allocation process of key sequence or the object view range on the view area of the output unit indicated by the object id in the storage unit changes and

the processing unit performs again the allocation process of the first press key sequence of the step of the (1).

(2)

“when either a first reference position of the output unit at the first allocation process of key sequence or the object id in the storage unit in the view area of the output unit changes” describes the situation when the first reference position or the view range of object indicated by object id on the view area of the output unit changed, that leads the change of the first positional relation. Therefore, it is effective to re-perform the allocation process of the first press key sequence in the step (1).

“when either a second reference position of the output unit at the second allocation process of key sequence or the object id in the storage unit in the view area of the output unit changes” describes the situation when the second reference position or the view range of object indicated by object id on the view area of the output unit changed, that leads the change of the second positional relation. Therefore, it is effective to re-perform the allocation process of the first press key sequence in the step (1)

“when either a first reference position of the output unit at the first allocation process of key sequence or the object id in the storage unit in the view area of the output unit changes” and “when either a first reference position of the output unit at the first allocation process of key sequence or the object id in the storage unit in the view area of the output unit changes” do not include the case in which the input-focus moves in accordance with the press key sequence by the relevant allocation process after the allocation process for either first or second press key sequence.

“re-perform the allocation process of the first press key sequence in the step (1)” means to reset the association between object id of storage unit and press key sequence and perform the allocation process of the first press key sequence in step (1). Examples of such cases may be deleting the association between object id and press key sequence from the storage unit or performing generation management while holding the association in the storage unit, re-performing the first allocation process of the press key sequence of step (1) and the resulted association between the press key sequence and object id to be targeted in the succeeding process.

(3)

In the present invention, when either of the first or the second reference position of the output unit as a result of the allocation process of the first or the second press key sequence or the object view range on the view area of the output unit indicated by the object id in the storage unit changes, after the allocation process of the first or the second press key sequence, the processing unit re-performs allocation process for the first press key sequence in step (1).

Thereby, when either of the first or the second reference position of the output unit as a result of the allocation process of the first or the second press key sequence or the object view range on the view area of the output unit indicated by the object id in the storage unit changes, the first allocation process of the press key sequence in step (1) is re-performed by resetting the press key sequence, which enables to have more effective press key sequence in the allocation process.

9

(1)

In other invention, the computer program is an operation-support computer program wherein, after either the first or second allocation process of key sequence has been performed, when detecting a command to reallocate the press key sequence in response to a press key targeting the reallocation process of press key sequence, the allocation process of the first press key sequence of the step of the (1) is performed again.

(2)

“detecting a command to reallocate the press key sequence in response to a press key by a user targeting the reallocation process of press key sequence the processing unit” is a command to reallocate the association between press key sequence of storage unit and object id. “Re-perform the allocation process of the first press key sequence in the step (1)” means to reset the association between object id of storage unit and press key sequence and perform the allocation process of the first press key sequence in step (1). Examples of such cases may be deleting the association between object id and press key sequence from the storage unit or performing generation management while holding the association in the storage unit re-performing the first allocation process of the press key sequence of step (1) and the resulted association to be targeted in the succeeding process.

(3)

In the present invention, after either the first or second allocation process of key sequence has been performed when detecting a command to reallocate the press key sequence in response to a press key targeting the reallocation process of press key sequence, when detecting a command to reallocate the press key sequence in response to a press key by a user targeting the reallocation process of press key sequence the processing unit, the processing unit performs again the allocation process of the first press key sequence of the step of the (1).

Thereby, re-performing the first allocation process of the press key sequence in step (1) by resetting the press key sequence when detecting a command to reallocate the press key sequence in response to a press key by the user targeting the reallocation process of press key sequence, which enables to have more effective press key sequence in the allocation process.

10

(1)

In other invention, there is an operation-support computer program, wherein the association between press key sequence and object id of the fixed press key sequence object is excluded from the process of the step (1) and step (3) other than the process of focus change by the processing unit, instead, allocation of the fixed press key sequence object is performed, that is moving an input-focus to an identified object in response to a press of the identified press key of the input unit or a combined and consecutive press of the at least two identified press keys of the input unit.

(2)

“the association between press key sequence and object id of the fixed press key sequence object” indicates an association between press key sequence of storage unit and object id, which is stored as fixed information in the computer program relating to the present invention.

“is excluded from the process of the step (1) and step (3) other than the process of focus change” means that the association between press key sequence of storage unit and object id regarding the fixed press key sequence is excluded from each process of the step (1) and step (3), such as deleting or updating the association, other than the focus-movement process because the association between press key sequence of storage unit and object id is stored as fixed information in the computer program relating to the present invention.

“from each process of the step (1) and step (3) other than the focus-movement process” corresponds to the allocation process of the first press key sequence, deletion press key sequence, updating allocation process of press key sequence, and the allocation process of the second press key sequence.

(3)

In this invention, the association between press key sequence and object id of the fixed press key sequence object is excluded from the process of the step (1) and step (3) other than the process of focus change by the processing unit and, instead, allocating the fixed press key sequence object, that is moving an input-focus to an identified object in response to a press of the identified press key of the input unit or a combined and consecutive press of the at least two identified press keys of the input unit.

Thereby, the association between press key sequence and object id of the fixed press key sequence object is excluded from the process of the step (1) and step (3) other than the process of focus change by the processing unit and, instead, allocating the fixed press key sequence object, this enables to move the input-focus to the fixed press key sequence object by pressing the fixed press key sequence regardless of how the allocation process of press key sequence has been performed.

11

(1)

In other invention, there is an operation-support computer program, wherein for one object id, the allocation process of the press key sequence is only performed to one press key sequence in which the allocation process of press key sequence stores the association between the press key sequence and object id, both in the first allocation process of press key sequence at the step (1) and in the second allocation process of press key sequence at the step (3) performed by the processing unit.

(2)

“for an object id, the allocation process of the press key sequence is only performed to one press key sequence” means one object id of storage unit are not associated to plural of press key sequences as the result of the allocation process of press key sequence that associates the press key sequence of storage unit and object id.

(3)

In the present invention, for one object id, the allocation process of the press key sequence is only performed to one press key sequence in which the allocation process of press key sequence that stores the association between the press key sequence and object id, both in the first allocation process of press key sequence at the step (1) and in the second allocation process of press key sequence at the step (3) performed by the processing unit.

Thereby, each object can be reached by short sequence of press key because, for one object id, the allocation process of the press key sequence is only performed to one press key sequence by using the press key sequence efficiently.

12

(1)

In other invention, there is an operation-support computer system, wherein, it comprises a storage unit configured to store information, a processing unit configured to process information, an output unit configured to output information to a user, and an input unit configured to receive a command from a user, wherein the storage unit stores each information described and operation computer program described, and the processing unit performs the each process.

As stated above, this invention can support an operation for input-focus movement by using limited numbers of press keys when a user operates computer with limited number of press keys in the multiple window system.

### BRIEF DESCRIPTION OF THE DRAWINGS

For more thorough understanding of the present invention and advantages thereof, the following description should be read in conjunction with the accompanying drawings, in which:

FIG. 1 is a process flow diagram 1 of an operation-support computer system.

FIG. 2 is a process flow diagram 2 of an operation-support computer system.

FIG. 3 is a process flow diagram 3 of an operation-support computer system.

FIG. 4 is a process flow diagram 4 of an operation-support computer system.

FIG. 5 is a process flow diagram 5-1 of an operation-support computer system.

FIG. 6 is a process flow diagram 5-2 of an operation-support computer system.

FIG. 7 is a process flow diagram 5-3 of an operation-support computer system.

FIG. 8 is a process flow diagram 5-4 of an operation-support computer system.

### DETAILED DESCRIPTION OF THE EMBODIMENTS

Hereinafter, embodiments of the present invention will be explained referring to drawings.

1. Embodiments of the Present Invention

(1)

An operation-support computer system is comprised of an output unit, a processing unit, an input unit and a storage unit. These each unit is possible to be connected electrically each other and to communicate information (signal communication) through a bus.

Components of the operation-support computer system will be explained in more detail. The output unit is a device to display information to the user of the operation-support computer system, which corresponds, for example, to a display. The storage unit is an auxiliary storage device to which a large amount of information is stored, or a main storage device to which information as an object of execution by processing unit is stored, which corresponds, for example, to a hard disk drive (HDD) or a main memory. The input unit is an input equipment that receives a command from the user of the operation-support computer system, which correspond to, for example, an input equipment in computer system such as a keyboard, a mouse, a touch-panel, etc.

And the processing unit is a calculating equipment that works with above other means (devices), which corresponds, for example, to arithmetic logic unit such as CPU.

Bus is a transmission path through which each unit communicates information each other inside the operation-support computer system.

The operation-support computer system of the present invention is also feasible in a local computer system such as a personal computer, and hereinafter, the operation will be explained in accordance with this premise.

However, the operation-support computer system of the present invention may be comprised of multiple computer systems.

For example, the operation-support computer system of the present invention can be comprised of multiple computer systems, a computer system at the client side as the output unit and the input unit, a computer system at the server side as the processing unit and the storage unit, and broadband communication line as the bus.

(2)

Next, various information stored in HDD as the storage unit of the operation-support computer system will be explained.

HDD as the storage unit stores various types of database, operation-support computer programs and other programs including OS as a form of database or file.

As information stored in a form of database or file, an object id that identifies an object and an object view range that represents view range of object on the view area of the output unit are associated to each other and stored an associated result.

The storage unit is configured to store a press key sequence indicative of an identified press key of the input unit or a combination of the at least two identified press keys of the input unit, and allocating priority for press key sequence to the objects id, both of which are associated with each other. The storage unit is configured to store the press key sequence, and an image of press key sequence that is an image indicative of the identified press key sequence of the input unit or a combination of the at least two identified press keys of the input unit, both of which are associated with each other. Further, the storage unit is also configured to store association between the press key sequence and the object, which is information on the fixed press key sequence object.

Among various information stored as types of database or file, there is a case that there exist two or more databases or files of the same type. For example, there is a case that two or more pieces of database about the association between the object id and the object view range exist.

CPU as the processing unit reads each information, which is stored in HDD as the storage unit, into the memory as the storage unit, interprets and executes the programs or the data.

The operation-support process relating to the present invention is performed, as the CPU as the processing unit reads the OS and other programs including the operation-support computer programs stored into HDD as the storage unit, interpret and executes them.

Like this, in the present embodiment, the operation is explained assuming that each information has been stored in HDD as the storage unit at an initial state. However, it is of course possible to execute the operation even if each information is stored in the memory as the storage unit at the initial state.

2 Execution Flow of the Present Invention

(1)

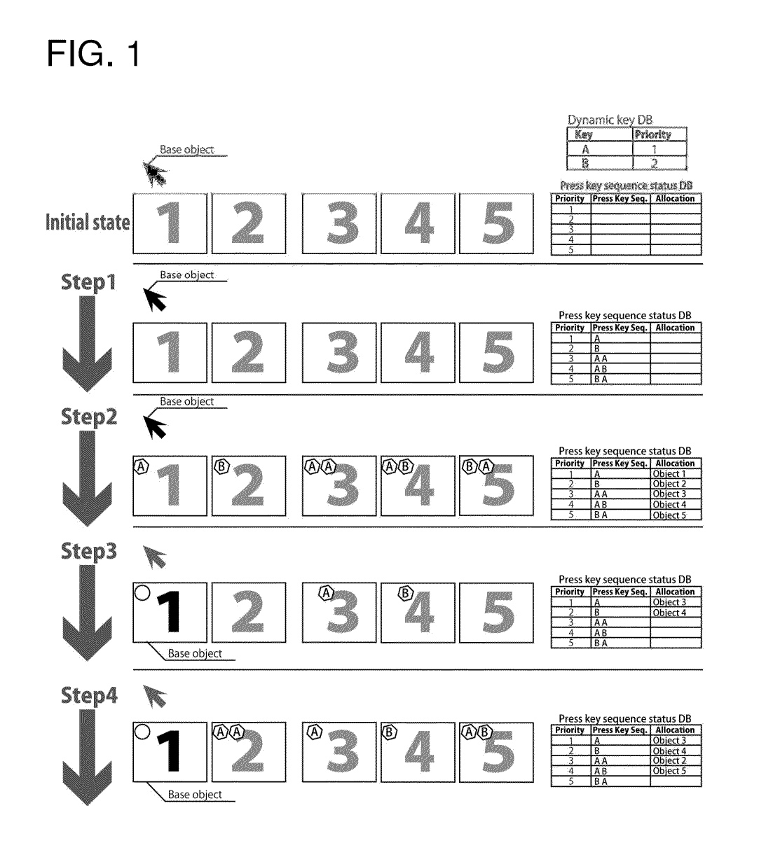

FIG. 1 is an example of process flow chart executed by the operation-support computer system relating to the present invention. According to this flow chart, execution flow of the present invention will be explained.

Firstly, if a command of operation-support is received through the input unit, CPU as the processing unit, performs a first allocation process of press key sequence, whereby, CPU, for an object identified by the object id stored in the storage unit out of the objects on the view areas of the output unit, calculates the first positional relation that is a positional relation between a first reference position of the output unit and the object view range associated with the object id in the storage unit, identifies association between the allocation priority for press key sequence and the press key sequence for the identified object id, on the basis of the calculated first positional relation, and performs an allocation process of press key sequence, that is, associates the identified press key sequence with the object id and stores an associated result in the storage unit, to an object id stored in the storage unit.

In the process flow of FIG. 1, Step 1 and Step 2 correspond to the above processing.

In more specifically, CPU in Step 1 and Step 2 of process flow of FIG. 1, for an object identified by the object id (object 1 to 5) stored in the storage unit out of the objects (object 1 to 5) on the view areas of the output unit, and calculates the first positional relation that is a relation between a first reference position of the output unit (the reference position is determined with reference to the view area of mouse cursor, input cursor) and the object view range associated with the object id in the storage unit (the view area of each object of 1 to 5 on the output unit).

As a result above, CPU identifies association between the allocation priority for press key sequence and the press key sequence for the object id, on the basis of the calculated first positional relation,

In specifically, in the first positional relation calculated for object ids of object 1 to 5, object who is the nearest to the reference position is object 1 followed by object 2, 3, 4 and 5. Thus, “A” that has the highest allocation priority of press key sequence is allocated to the object 1. Similarly, the press key sequence “B”, “AA”, “AB”, “BA” as are allocated to object 2, object 3, object 4, and object 5, respectively,

For judging the calculated positional relation, there are various calculation methods such as: to consider only X-axis positional relation, to consider only Y-axis positional relation, to consider X- and Y-axis positional relation, and to multiply a constant coefficient to positional relation of X- and Y-axis.

The first allocation process of press key sequence which performs the allocation process of press key sequence that associates identified press key sequence (A to BA) and the object id (object 1 to 5) respectively and stored the associated result in the storage unit.

Thereby, it becomes the press key sequence status DB after the Step 2 in process flow of FIG. 1. As shown in FIG. 1, the association between press key sequence and object id are stored.

(2)

Next, CPU as the processing unit, based on the association between the press key sequence and the object id in the storage unit, and based on the association between the press key sequence and the image of press key sequence in the storage unit, identifies the press key sequence associated with the object id in the storage unit, identifies the image of press key sequence associated with the identified press key sequence, and performs an image-display process of press key sequence, that is, displaying the identified image of press key sequence with reference to a view range of the output unit based on the object view range associated with the objet id. Thereby CPU notifies the user of the computer system of a press-key sequential relation, that is, which object to be reached by the input-focus in response to a press of the identified press key of the input unit or a combined and consecutive press of the at least two identified press keys of the input unit, in a current display state of the output unit;

Step 2 in the process flow of FIG. 1 corresponds to the above flow.

In more concretely, in Step 2 in process flow of FIG. 1, CPU, based on association between the press key sequence (A to BA) and the object id (object 1 to 5) in the storage unit, and based on the association between the press key sequence (A to BA) and the image of press key sequence (display image A to BA) in the storage unit, identifies the press key sequence (A to BA) associated with the object id (object 1 to 5) in the storage unit, identifies the image of press key sequence (display image A to BA) associated with the identified press key sequence (A to BA), and performs an image-display process of press key sequence, that is, displaying the identified image of press key sequence (display image A to BA) with reference to a view range of the output unit based on the object view range (view range of object 1 to 5 on the output unit) associated with the objet id (object 1 to 5), thereby notifies the user of the computer system of a press-key sequential relation, that is, which object to be reached by the input-focus in response to a press of the identified press key of the input unit or a combined and consecutive press of the at least two identified press keys of the input unit, in a current display state of the output unit;

Thereby, it becomes the present display state of the output unit after the Step 2 in process flow of FIG. 1. As shown in FIG. 1, the identified images of press key sequence (display image A to BA) are displayed at the upper left area of each object with reference to on the object view range (view range of object 1 to 5 on the output unit) of the output unit associated with the objet id (object 1 to 5), User of computer system are able to know a press-key sequential relation of the current display state of the output unit, that is, which object to be reached by the input-focus in response to a press of the identified press key of the input unit or a combined and consecutive press of the at least two identified press keys of the input unit.

(3)

Next, CPU as the processing unit, after the first allocation process of press key sequence, when detecting a command to change the object to be targeted by the input-focus in response to a press of the identified press key of the input unit by the user, performs an input-focus movement process, that is, identifying from the storage unit the object id associated with the press key sequence identical to the identified press key, and moving the input-focus to the object indicated by the identified object id, performs a deletion process of press key sequence, that is, deleting association of the object id with the press key sequence, whose head does not include the identified press key pressed by the user under a change command and which is identical to the identified press key pressed by the user under the change command out of any association between the press key sequence and the object id in the storage unit, identifying all the press key sequences whose head include the press key pressed by the user under the change command and which is constituted by combining the at least two identified press keys of the input unit from the storage unit, identifying the object id associated with said each press key sequence from the storage unit, and deleting association there between from the storage unit, performs an updating allocation process of press key sequence, that is, deleting the identified press key pressed by the user included in a head of said each press key sequence, thereby obtaining a new press key sequence and associating the new press key sequence with the object id having the association deleted therefrom, and storing an associated result in the storage unit, as a second allocation process of press key sequence, for the object id of the object having no input-focus and not associated with press key sequence in the storage unit, out of the objects on the view area of output unit,

calculates a second position relation that is a relation between a second reference position of the output unit and the object view range associated with the object id in the storage unit, identifies the association between the allocation priority for the press key sequence and the press key sequence, on the basis of the calculated second positional relation, for the object id from the storage unit, performs an allocation process of press key sequence, that is, associating the identified press key sequence with the object id and storing an associated result in the storage unit, also performs an image-display process of press key sequence of the step of the (2), and notifies the user of the operation-support computer system of a new press-key sequential relation;

In the process flow of FIG. 1, Step 3 and Step 4 correspond to the above processing.

In more concretely, in Step 3 of process in FIG. 1, after the first allocation process of press key sequence has been performed, CPU performs an input-focus movement process, when detecting a command to change the object to be targeted by the input-focus in response to a press of the identified press key of the input unit (A) by the user that is, identifying from the storage unit the object id (object 1) associated with the press key sequence (A) identical to the identified press key (A), and moving the input-focus to the object (object 1) indicated by the identified object id (object 1), performs a deletion process of press key sequence, that is, deleting association of the object id (object 2, 5) with the press key sequence (B, BA), whose head does not include the identified press key pressed by the user (A) under a change command and object id (object 1) associated with press key sequence (A) which is identical to the identified press key pressed by the user(A) under the change command out of any association between the press key sequence (A to BA) and the object id (object 1 to 5) in the storage unit,

Thereby, it becomes a status of press key sequence status DB after Step 3 of process flow in FIG. 1.

CPU identifies all the press key sequence (AA, AB) whose head includes the press key pressed by the user (A) under the change command and which is constituted by combining the at least two identified press keys of the input unit (AA, AB) from the storage unit, and identifies the object id (object 3,4) associated with the said each press key sequence (AA, AB) from the storage unit, and deletes the association there between from the storage unit,

performs an updating allocation process of press key sequence, that is, deleting the identified press key pressed by the user (A) included in a head of said each press key sequence (AA, AB), thereby obtaining a new press key sequence (A, B) and associating the new press key sequence with the object id (object3, 4) having the association deleted therefrom, and storing the associated result in the storage unit,

as a second allocation process of press key sequence, for the object id of the object having no input-focus (object 2, 5) and not associated with press key sequence in the storage unit, out of the objects (object 1 to 5) on the view area of output unit,

calculates a second position relation that is a relation between a second reference position (object 1 having an input-focus) of the output unit and the object view range associated with the object id (object 2, 5) in the storage unit,

identifies association between the allocation priority for press key sequence (3, 4) and the press key sequence (AA, AB), on the basis of the calculated second positional relation, for the object id (object 2, 5) from the storage unit, and

performs an allocation process of press key sequence, that is, associating the identified press key sequence (AA, AB) with the object id (object 2, 5) and storing an associated result in the storage unit.

Further, in Step 4 of process flow in FIG. 1, CPU also performs an image-display process of press key sequence of the step of the (2), and notifies the user of the operation-support computer system of a new press-key sequential relation

Thereby, it becomes a present display state of the output unit after the Step 4 in process flow of FIG. 1. CPU displays the identified image of press key sequence (display image A to AB) at the upper left area of each object with reference to the view range of the output unit based on the object view range (view range of object 2 to 5 on the output unit) associated with the objet id (object 2 to 5). An user of computer system are able to know a press-key sequential relation, that is, which object to be reached by the input-focus in response to a press of the identified press key of the input unit or a combined and consecutive press of the at least two identified press keys of the input unit, of the current display state of the output unit.

(4)

Next, CPU, when detecting a command to change the object to be targeted by the input-focus in response to a press of the identified press key of the input unit by the user after the second allocation process of press key sequence has been performed, performs each process of the step of the (3),

In process flow of FIG. 1, after the processing of Step 4 has been executed, Step 3 and Step 4 are re-executed.

(5)

The first reference position of the output unit at the first allocation process of press key sequence may be determined with reference to the view area of an object having an input-focus as well as a mouse cursor, or an input cursor, which are displayed on the view area of the output unit.

(6)

In Step 3 and Step 4 in process flow of FIG. 1, CPU as the processing unit may execute the following process:

As a first allocation process of press key sequence, after the first allocation process of press key sequence has been performed, when detecting a command to change the object to be targeted by the input-focus in response to a press of the identified press key of the input unit (A) by the user, CPU performs an input-focus movement process, that is, identifying from the storage unit the object id (object 1) associated with the press key sequence (A) identical to the identified press key (A), and moving the input-focus to the object (object 1) indicated by the identified object id (object 1),

identifies all the press key sequence whose head includes the identified press key pressed by the user (A) under the change command and which is constituted by combining the at least two identified press keys of the input unit (AA, AB) from the storage unit out of any association between the press key sequence (A to BA) and the object id in (object 1 to 5) the storage unit,

for each press key sequence (AA, AB), performs an updating allocation process of press key sequence, that is, deleting from said each press key sequence the identified press key pressed by the user (A) included in a head of said each press key sequence, thereby obtaining a new press key sequence (A, B) and associating the new press key sequence with the object id (object 3, 4) having the association deleted therefrom, and stores an associated result in the storage unit,

renews association between press key sequence and the object id (object 3, 4) to the latest association between press key sequence (A, B) and the object id (object 3, 4) after the update process

for the object id of the object having no input-focus and not associated with press key sequence in the storage unit (object 2, 5), out of the objects on the view area of output unit (object 1 to 5),

calculates a second position relation that is a relation between a second reference position of the output unit (object 1 which has an input-focus), and the object view range associated with the object id (object 2, 5) in the storage unit,

identifies the association between the allocation priority for press key sequence (3, 4) and the press key sequence (AA, AB), on the basis of the calculated second positional relation, for the object id (object 2, 5) from the storage unit,

performs an allocation process of press key sequence, that is, associating the identified press key sequence (AA, AB) with the object id (object 2, 5) and storing an associated result in the storage unit, performs an image-display process of press key sequence, and notifies the user of the operation-support computer system of a new press-key sequential relation.

Further, after the second allocation process of press key sequence of Step 3 and Step 4 in FIG. 1, when detecting a return command of press key sequence in response to a press of the identified press key of the input unit by the user, the CPU as a procession unit regards the association between press key sequence (A to AB) and object id (object 1 to 5) of one generation before the updating allocation process of press key sequence to be the latest association between press key sequence (A to AB) and object id (object 1 to 5), performs an input-focus movement process, that is, moving back to the input-focus to the object that had an input-focus (mouse cursor or input cursor) before the input-focus movement process.

(7)

CPU as the processing unit may execute the following process:

CPU associates the identified press key id (A, B) of the input unit and press key allocation priority (1, 2) indicative of allocation priority between the identified press keys of the input unit and store an associated result. In FIG. 1, “dynamic key database” corresponds to this.

CPU, as the processing unit, performs a creation process of press key sequence that is, associating the allocation priority for press key sequence (1, 5) and the press key sequence (A to BA) wherein the allocation priority rule defining priorities between identified press keys of the input unit indicative of the association between allocating priority for press key sequence (1, 2) and the input key id (A, B) stored in the storage unit and storing an associated result in the storage unit, and

associates between allocation priority of press key sequence (1 to 5) of the storage unit and the press key sequence (A to BA).

In FIG. 1, the association between the allocation priority of the press key sequence and press key sequence of the storage unit corresponds to “press key sequence status DB”.

(8)

CPU as the processing unit may execute the following process:

After the first allocation process of key sequence has been performed when either a first reference position (mouse cursor or input cursor) of the output unit at the first allocation process of key sequence or the view area on the output unit of the object indicated by the object id (object 1 to 5) in the storage unit changes and after the second allocation process of key sequence has been performed when either a second reference position (object 1 as an object with input-focus) of the output unit at the second allocation process of key sequence or the view area on the output unit of the object indicated by the object id (object 1 to 5) in the storage unit changes, CPU performs again the allocation process of the first press key sequence.

(9)

CPU as the processing unit may execute the following process:

After the first or the second allocation process of key sequence, when detecting a command to reallocate the press key sequence in response to a press key targeting the reallocation process of press key sequence, CPU performs again the allocation process of the first press key sequence.

(10)

CPU as the processing unit may execute the following process:

For an object id, the allocation process of the press key sequence is only performed to one press key sequence at the allocation process of press key sequence that stores the association between the press key sequence and object id both in the first and the second allocation process of press key sequence at the step.

(11)

As the result of information processing that a series of hardware resources operate cooperatively, the present invention supports the user's operation to move input-focus with limited number of keys when the user operates a computer of which numbers of press keys of input unit is limited in a multiple window environment.

3. Implementation Flow 2 of the Present Invention

(1)

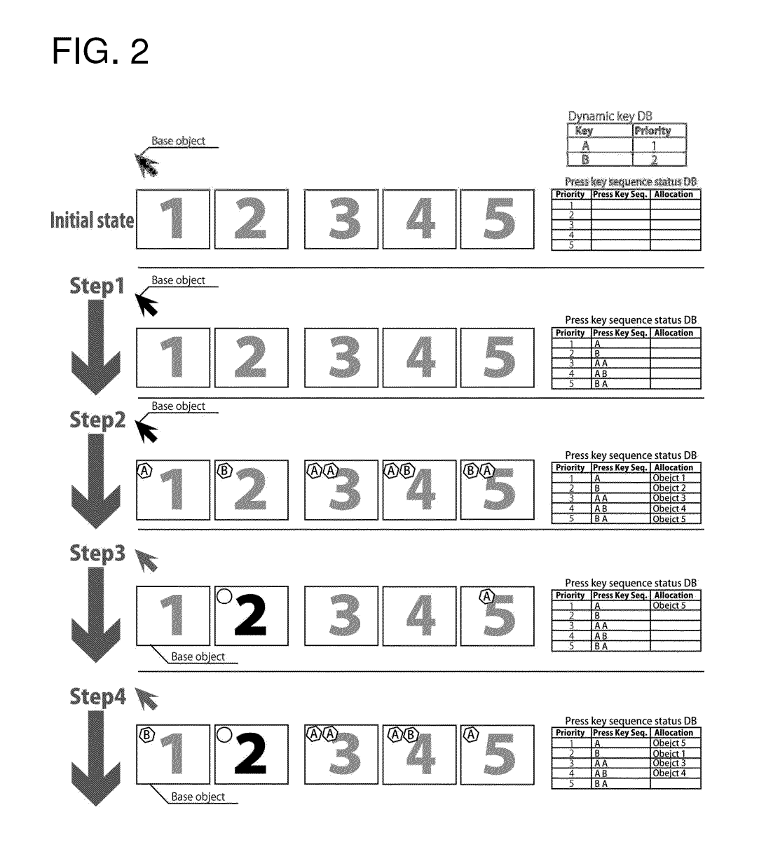

FIG. 2 is another example of process flow chart executed by an operation-support computer system relating to the present invention. Difference of process in FIG. 1 and FIG. 2 is a key pressed by the user in detecting a command to change the object to be targeted by the input-focus in response to a press of the identified press key of the input unit by the user after the first allocation process of press key sequence has been performed. More specifically, “A” and “B” are pressed after the first allocation process of press key sequence in FIG. 1 and FIG. 2 respectively.

4. Implementation Flow 3 of the Present Invention

(1)

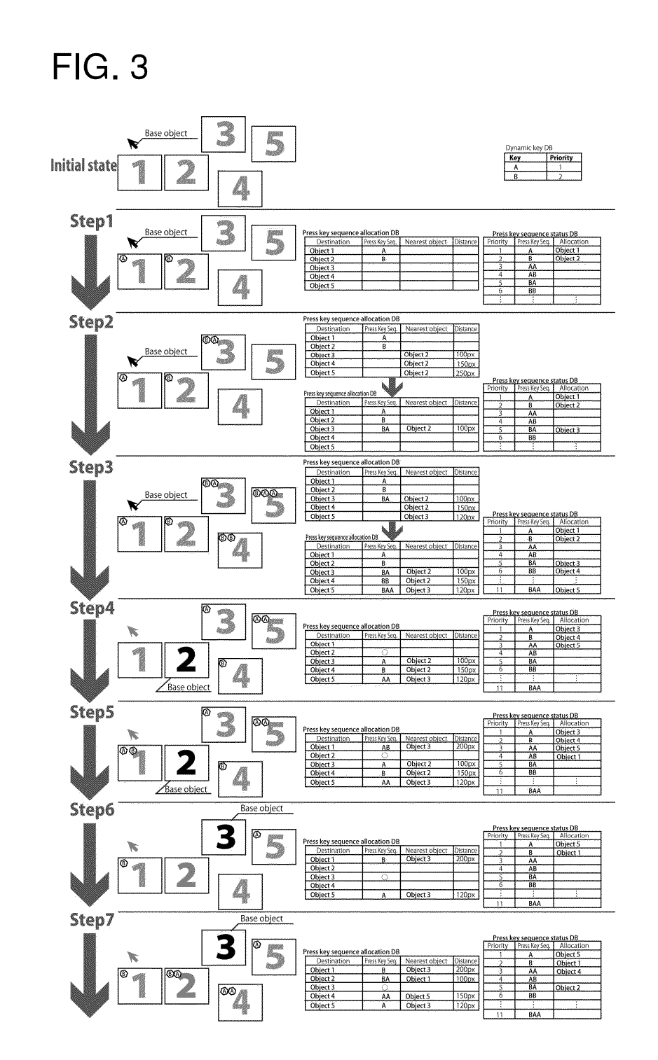

FIG. 3 is another example of process flow chart executed by an operation-support computer system relating to the present invention.

The difference between FIG. 1 and FIG. 3 are found in the following. The first reference position of the output unit at the first allocation process of press key sequence is determined with reference to the view area of an object having the highest priority on the view area of the output unit on which an object indicated by the object id targeted for the first allocation process of press key sequence is also displayed, out of displayed objects on the view area of the output unit, that is, an object having an input-focus, a mouse cursor, an input cursor, and an object to which allocation process of press key sequence has already been applied.

For the allocation process of press key sequence of a combination of the at least two identified press keys of the input unit, as the first allocation process of press key sequence, when plurality of object ids are reference to the same first reference position, for the object id with the highest priority in the first positional relation, CPU performs the allocation process of press key sequence, wherein performing the allocation process of press key sequence that associates between the object id and the identified press key sequence, which is one added identified press key sequence to the press key sequence allocated to the object of the first reference position, and which is the highest in the allocation priority in the press key sequence in the storage unit and not yet allocated to any object, repeating the allocation process of the press key sequence until the first termination condition is satisfied while adding objects performed the allocation process of the press key sequence to the first reference position, and

performs the second allocation process of press key sequence, wherein the second reference position of the output unit at the second allocation process of key sequence is determined with reference to the view area of the object having the highest priority on the view area of the output unit indicated by an object id to be targeted by the object of the second allocation process of press key sequence out of the object having an input-focus, and the object to which allocation process of press key sequence has already been applied to. For the allocation process of press key sequence of a combination of the at least two identified press keys of the input unit, as the second allocation process of press key sequence, when plurality of object ids are reference to the same second reference position, for an object id with the highest priority in the second positional relation, CPU identifies the press key sequence having the highest priority from the storage unit of which press key sequences having one added identified press key to the press key sequence allocated to the reference object of the second reference position and not yet performed the allocation process of the press key sequence and, performs the allocation process of press key sequence that associates between the object id and the identified press key sequence, and repeats the allocation process of the press key sequence until the second termination condition is satisfied while adding objects performed the allocation process of the press key sequence to the second reference position.

In more concretely, in Step 3 of process flow in FIG. 3, the first reference position of the output unit at the first allocation process of press key sequence is determined with reference to a view area of an object having the highest priority (mouse cursor or input cursor) on the view area of the output unit on which an object (object 1 to 5) indicated by object id (object 1 to 5) targeted of the first allocation process of press key sequence is also displayed, out of displayed objects on the view area of the output unit, that is, an object having an input-focus, a mouse cursor, an input cursor, and an object to which allocation process of press key sequence has already been applied. For an object identified by the object id (object 1 to 5) stored in the storage unit out of the objects (object 1 to 5) on the view areas of the output unit, CPU calculates the first positional relation that is a relation between the first reference position of the output unit (mouse cursor or input cursor) and the object view range associated with the object id in the storage unit (object 1 to 5), identifies association between the allocation priority (1 to 2) for the press key sequence (A to B) and the press key sequence for the object id (object 1 to 5) on the basis of the calculated first positional relation, associates the each of the object id (object 1, 2) and the object id (object 1, 2) and stores an associated result in the storage unit as the allocation key process.

In Step 2 of process flow in FIG. 3, for the allocation process of press key sequence of a combination of the at least two identified press keys of the input unit (AA, AB, BA), when plurality of object ids (object 3-5) are reference to the same first reference position (object 2), for an object id with the highest priority in the first positional relation (object 3), CPU performs the allocation process of press key sequence, wherein performing the allocation process of press key sequence that associates between the object id (object 3) and the identified press key sequence(BA), which is one added identified press key sequence to the press key sequence (B) allocated to the object (object 2) of the first reference position, and which is the highest in the allocation priority in the press key sequence (BA) in the storage unit and not yet allocated to any object.

In Step 3 of process flow in FIG. 3, CPU repeats the allocation process of the press key sequence until the first termination condition is satisfied while adding objects performed the allocation process of the press key sequence to the first reference position, and performs the first allocation process of press key sequence.

In concretely, CPU performs the allocation process of press key sequence, which performs the allocation process of press key sequence that associates between the object id (object 4) and the identified press key sequence (BB), which is one added identified press key sequence to the press key sequence allocated (B) to the object of the first reference position (object 2), and which is the highest in the allocation priority in the press key sequence (BB) in the storage unit and not yet allocated to any object, further, and performs the allocation process of press key sequence, which performs the allocation process of press key sequence that associates between the object id (object 5) and the identified press key sequence (BAA), which is one added identified press key sequence to the press key sequence allocated (BA) to the object of the first reference position (object 3), and which is the highest in the allocation priority in the press key sequence (BAA) in the storage unit and not yet allocated to any object.

(2)

Then, as the result of Step 3 of process flow in FIG. 3, based on association between the press key sequence (A, B, BA, BB, BAA) and the object id (object 1 to 5) in the storage unit, and based on association between the press key sequence (A, B, BA, BB, BAA) and the image of press key sequence in the storage unit, CPU identifies the press key sequence associated with the object id (object 1 to 5) in the storage unit, identifies the image of press key sequence associated with the identified press key sequence (A, B, BA, BB, BAA), performs an image-display process of press key sequence, that is, displaying the identified image of press key sequence(A, B, BA, BB, BAA) with reference to a view range of the output unit based on the object view range associated with the objet id (object 1 to 5), thereby and notifies the user of the computer system of a press-key sequential relation, that is, which object to be reached by the input-focus in response to a press of the identified press key of the input unit or a combined and consecutive press of the at least two identified press keys of the input unit, in a current display state of the output unit.

(3)

Further, in Step 4 of process flow in FIG. 3, when detecting a command to change the object to be targeted by the input-focus in response to a press of the identified press key (B) of the input unit by the user after the first allocation process of press key sequence, CPU performs an input-focus movement process, that is, identifying from the storage unit the object id (object 2) associated with the press key sequence (B) identical to the identified press key (B), and moving the input-focus to the object indicated by the identified object id (object 2), identifies all the press key sequence (BA, BB, BAA) whose head includes the press key (B) pressed by the user under the change command and which is constituted by combining the at least two identified press keys (BA, BB, BAA) of the input unit from the storage unit,

out of the associations between the press key sequence (A, B, BA, BB, BAA) and object ids (object 1-5), performs an updating allocation process of press key sequence, that is, deleting the identified press key pressed by the user (B) included in a head of said each press key sequence from said each press key sequence (BA, BB, BAA), thereby obtaining a new press key sequence (A, B, AA) and associating the new press key sequence (A, B, AA) with the object id (object 3 to 5) having the association deleted therefrom, and stores an associated result in the storage unit,

(4)

Further, in Step 5 of process flow in FIG. 3, CPU performs the second allocation process of press key sequence whereby, for the object id of the object having no input-focus (object 1) and not associated with press key sequence in the storage unit, out of the objects on the view area of output unit, calculates a second position relation that is a relation between a second reference position (object 3) of the output unit and the object view range associated with the object id (object 1) in the storage unit, identifies association between the allocation priority (4) for press key sequence and the press key sequence (AB), on the basis of the calculated second positional relation, for the object id (object 1), and performs an allocation process of press key sequence, that is, associating the identified press key sequence (AB) with the object id (object 1) and storing an associated result in the storage unit.

In Step 5 of process flow in FIG. 3, CPU performs an image-display process of press key sequence, and notifies the user of the operation-support computer system of a new press-key sequential relation.

(5)

Further, in Step 6 of process flow in FIG. 3, when detecting a command to change the object to be targeted by the input-focus in response to a press of the identified press key of the input unit (A) by the user after the second allocation process of press key sequence has been performed, CPU performs an input-focus movement process, that is, identifying from the storage unit the object id (object 3) associated with the press key sequence (A) identical to the identified press key (A), and moving the input-focus to the object (object 3) indicated by the identified object id (object 3), identifies all the press key sequence (AA, AB) whose head includes the press key pressed by the user (A) under the change command and which is constituted by combining the at least two identified press keys of the input unit (AA, AB) out of the association between the press key sequence (A, B, AA, AB) and object id (object 1, 3-5) from the storage unit, performs an updating allocation process of press key sequence, that is, deleting the identified press key pressed by the user (A) included in a head of said each press key sequence (AA, AB) from said each press key sequence (AA, AB), thereby obtaining a new press key sequence (A, B) and associating the new press key sequence with the object id (object1, 5), and storing the associated result in the storage unit, and renews the association between the press key sequence and the object id to the latest association of the press key sequence (A, B) and the object id (object 1, 5).

(6)

Further, in Step 7 of process flow in FIG. 3, CPU performs the second allocation process of press key sequence, whereby, for the object id of the object having no input-focus and not associated with the press key sequence in the storage unit (object 2, 4), out of the objects on the view area of output unit, calculates the second position relation that is a relation between a second reference position (object 1, 5) of the output unit and the object view range associated with the object id (object 2, 4) in the storage unit and for the object id (object 2, 4) from the storage unit, identifies the association between the allocation priority (3, 5) for the press key sequence and the press key sequence (AA, BA) on the basis of the calculated second positional relation, associates the press key sequence (AA, BA) and the object id (object 2, 4), and stores associated results in the storage unit.

After Step 7 of process flow in FIG. 3, CPU performs an image-display process of press key sequence of the step of the (2), and notifies the user of the operation-support computer system of a new press-key sequential relation.

5. Implementation Flow 4 of the Present Invention

(1)

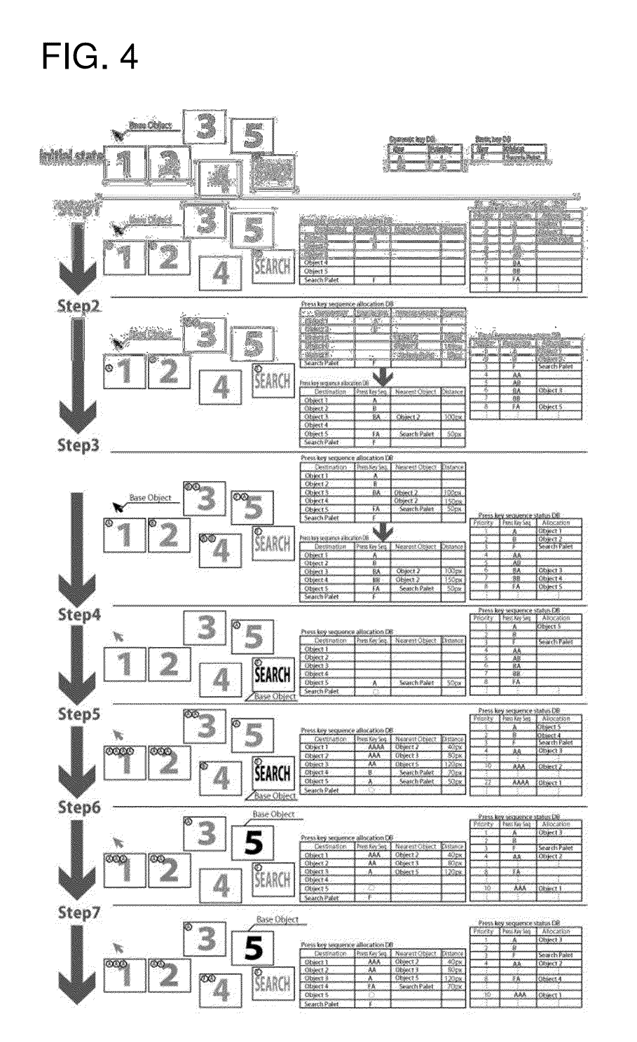

FIG. 4 is another example of process flow chart executed by an operation-support computer system relating to the present invention.

A difference of process in FIG. 3 and FIG. 4 is that since, in FIG. 4, the allocation of the fixed press key sequence object, that is moving an input-focus to an identified object in response to a press of the identified press key of the input unit or a combined and consecutive press of the at least two identified press keys of the input unit, has been processed. Therefore, the fixed press key sequence object are excluded from the allocation process of press key sequence, deletion process of press key sequence, and update process of the allocation of the press key sequence, which are processed by the processing unit.

6 Implementation Flow 5 of the Present Invention

(1)

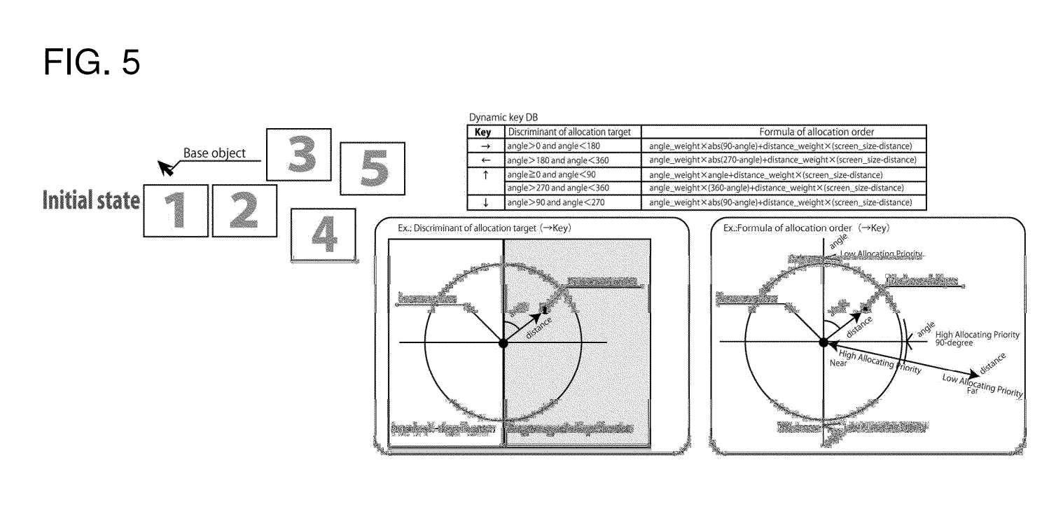

FIGS. 5-8 are other examples of process flow chart executed by an operation-support computer system relating to the present invention.

Difference between FIG. 1 and FIGS. 5 to 8 are found in the following. The first reference position of the output unit at the first allocation process of press key sequence is determined with reference to the view area of an object having an input-focus, a mouse cursor, an input cursor, and an object to which allocation process of press key sequence has already been applied,

for the first positional relation calculating a combination between the first reference position and the object id of the storage unit, for the allocation process of press key sequence of the at least two identified press keys, CPU identifies the press key sequence having the highest priority from the storage unit of which press key sequences has one added identified press key to the press key sequence allocated to the reference object of the first reference position and not yet performed the allocation process of the press key sequence,

performs the allocation process of key sequence on the first reference position, that is, associating the identified object id and the identified press key sequence with reference to the first positional relation calculated from the combination of the object id and first reference position, and storing an associated result in the storage unit, determines a new first reference position with reference to the view area of the object to which the process of allocation for press key sequence was applied in adjacent process and repeats the allocation process of the press key sequence until the first termination condition is satisfied.

The second reference position of the output unit at the second allocation process of press key sequence is determined with reference to the view range of the displayed object to which allocation process of press key sequence has already been applied and an displayed object having an input-focus on the view area. CPU calculates a combination between the second reference position and the object id of the storage unit for the second positional relation. For the allocation process of press key sequence of the at least two identified press keys, CPU identifies the press key sequence having the highest priority from the storage unit of which press key sequences having one added identified press key to the press key sequence allocated to the reference object of the second reference position and not yet performed the allocation process of the press key sequence and, performs the allocation process of key sequence, that is, associating the object id and the identified press key sequence with reference to the second positional relation calculated from the combination of the second reference position and the object id and storing an associated result in the storage unit, determines the new second reference position with reference to the view area of the object to which the process of allocation for press key sequence was applied in adjacent process and repeats the allocation process of the press key sequence until the second termination condition is satisfied.

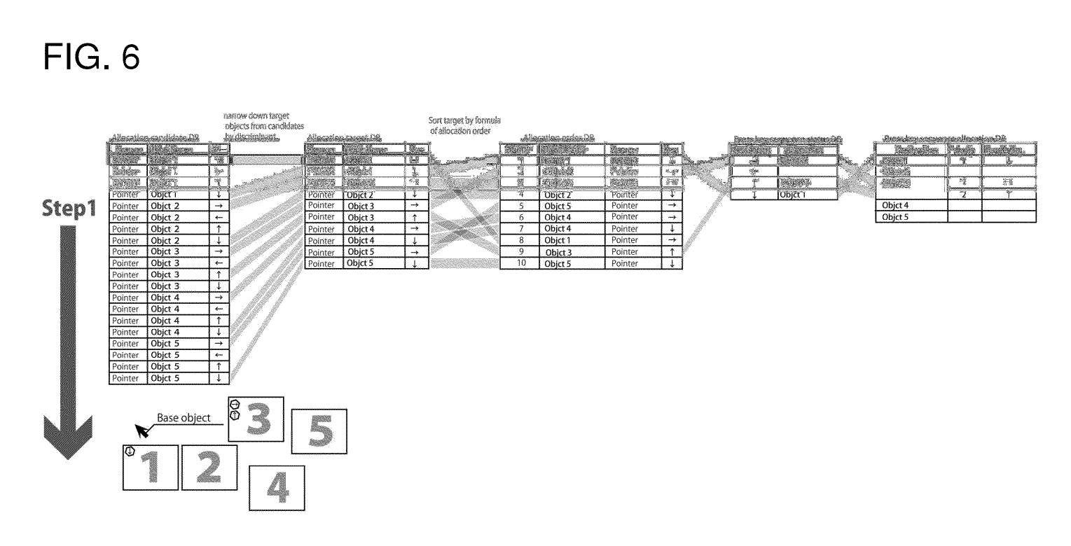

In more concretely, in “Initial state” and Step 1 in FIG. 5 and FIG. 6, the first reference position of the output unit is determined with reference to the view area of mouse cursor (reference object) on the view area of output unit, and the first positional relation is calculated by combining press key sequence (each press key of right-arrow key, up-arrow key, down-arrow key, left-arrow key) to the association between the first reference position (reference object) and object id (object 1-5) of storage unit.

CPU, for the object id from the storage unit, identifies association between the allocation priority for the press key sequence and the press key sequence, on the basis of the calculated first positional relation, and performs an allocation process of press key sequence, that is, associating the identified press key sequence (each press key of right-arrow key, up-arrow key, down-arrow key, left-arrow key) with the object id (object 1, 3) and storing an associated result in the storage unit. More specifically, when identifying association between the allocation priority for the press key sequence and the press key sequence for identified object id, on the basis of the calculated first positional relation, CPU narrows the target by “allocation target determination formula” then judges the allocation priority by “allocation priority calculating formula”.

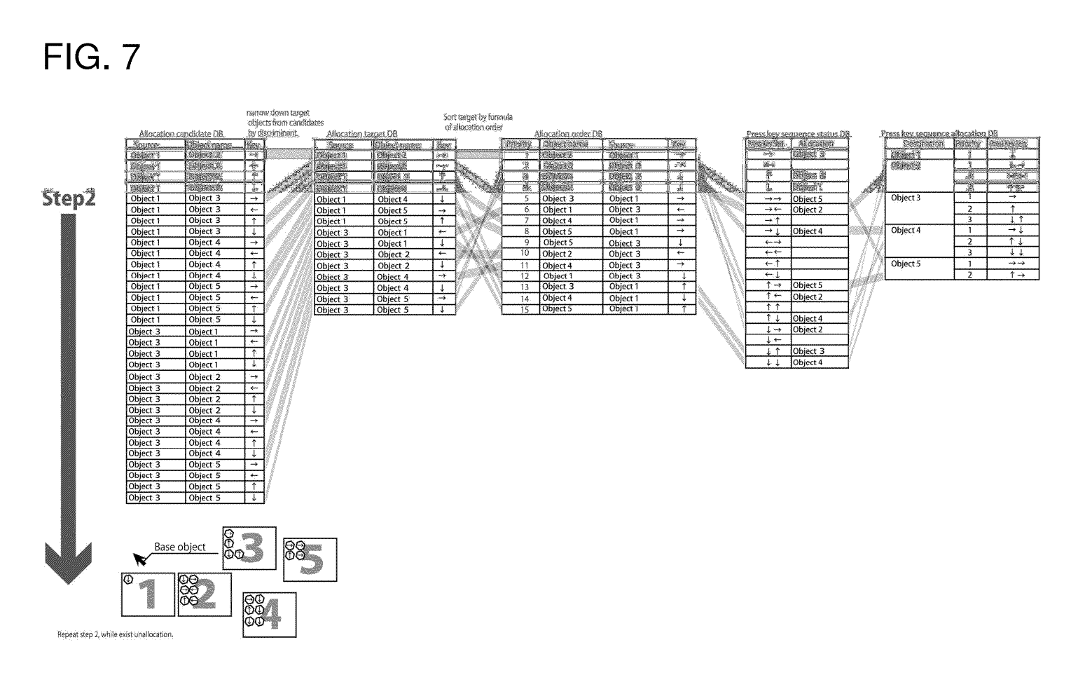

In Step 2 of FIG. 7 for the allocation process of press key sequence which is a combination of the at least two identified press keys, CPU determines a new first reference position (object 1, 3) with reference to the view area of the object to which the allocation process for press key sequence was applied in adjacent process, identifies the press key sequence having the highest priority from the storage unit of which press key sequences having one added identified press key to the press key sequence allocated to the reference object (object 1,3) of the first reference position (each press key of right-arrow key, up-arrow key, down-arrow key) and not yet performed the allocation process of the press key sequence, performs the allocation process of key sequence on the first reference position (object 1,3), that is, based on the first positional relation calculated by associating the press key sequence (each press key of right-arrow key, up-arrow key, down-arrow key) with the association between the first reference position (object 1,3) and the object id (object 1 to 5) and, storing an associated result in the storage unit.

More specifically, for each identified object id, when identifying association between the allocation priority for press key sequence and the press key sequence on the basis of the calculated first positional relation, CPU narrows the target by “allocation target determination formula” then judges the allocation priority by “allocation priority calculating formula”.

CPU repeats the allocation process of press key sequence until the first termination condition is satisfied (at least one allocation process of press key sequence is performed to all object ids, that is object 1-5).

(2)

Thereby, it becomes a present display state of the output unit after the Step 2 in process flow of FIG. 7. As shown in FIG. 7, the identified image of press key sequence (display image as a combination of right-arrow key, up-arrow key, down-arrow key, left-arrow key) is displayed at the upper left area of each object with reference to the object view range (view range of object 1-5 on the output unit) of the output associated with the objet id (object 1-5),

The user of computer system is able to know the press-key sequential relation, that is, which object to be reached by the input-focus in response to a press of the identified press key of the input unit or a combined and consecutive press of the at least two identified press keys of the input unit, in a current display state of the output unit.

(3)

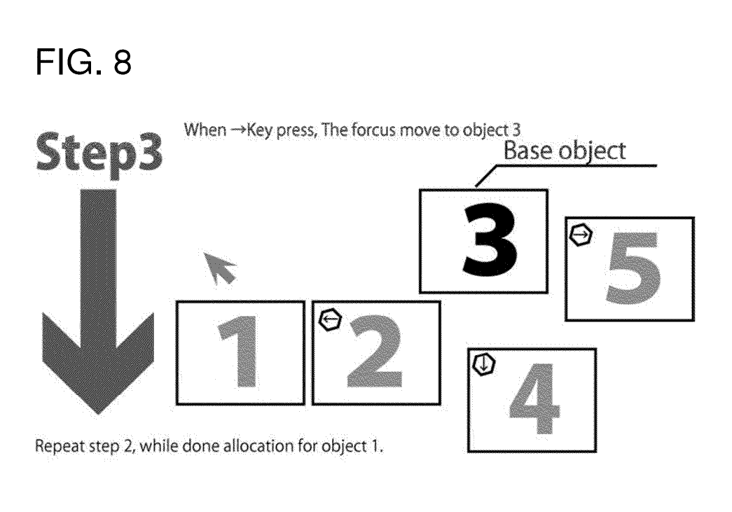

In Step 3 of FIG. 8, CPU as the processing unit, when detecting a command to change the object to be targeted by the input-focus in response to a press of the identified press key (right-arrow key) of the input unit by the user after the first allocation process of press key sequence, performs an input-focus movement process, that is, identifying from the storage unit the object id (object 3) associated with the press key sequence identical to the identified press key (right-arrow key), and moving the input-focus to the object (object 3) indicated by the identified object id (object 3).

CPU as the processing unit, as described above, repeats the allocation process of press key sequence until the second termination condition is satisfied (at least one allocation process of press key sequence is performed to all object ids other than object with input-focus).

1. An operation-support computer program executed on a computer system including a storage unit configured to store information, a processing unit configured to process information, an output unit configured to output information to a user, and an input unit configured to receive a command from the user, whereby a plurality of objects are displayed on a view area of the output unit and the user is allowed to control through the input unit an object having an input-focus out of the plurality of objects, the operation-support computer program configured to cause the processing unit to execute steps thereof,
the operation-support computer program comprising:
step (1) of performing a first allocation process of press key sequence, for the object identified by an object id stored in the storage unit out of the plurality of objects displayed on the view area of the output unit, wherein the storage unit is further configured to store the object id identifying the object, and an object view range indicative of a position/size of the object on the view area of the output unit, both of which are associated with each other, and store a press key sequence indicative of an identified press key of the input unit or a combination of at least two identified press keys of the input unit, and an allocation priority for press key sequence to the object id, both of which are associated with each other, and store the press key sequence, and an image of press key sequence that is an image indicative of the identified press key sequence of the input unit or a combination of the at least two identified press keys of the input unit, both of which are associated with each other, said step (1) including
calculating a first positional relation between a first reference position of the output unit and the object view range associated with the object id stored in the storage unit,
identifying association between the allocation priority for press key sequence and the press key sequence, on the basis of the calculated first positional relation, and
associating the identified press key sequence with the object id and storing an associated result in the storage unit, for the object id stored in the storage unit;
step (2) of performing an image-display process of press key sequence, for the object id stored in the storage unit, based on association between the press key sequence and the object id stored in the storage unit, and based on association between the press key sequence and the image of press key sequence stored in the storage unit, said step (2) including
identifying the press key sequence associated with the object id stored in the storage unit, and identifying the image of press key sequence associated with the identified press key sequence, and
displaying the identified image of press key sequence with reference to a view range of the output unit based on the object view range associated with the objet id, thereby notifying the user of the computer system of a press-key sequential relation as to the object to be reached by the input-focus in response to a press of the identified press key of the input unit or a combined and consecutive press of the at least two identified press keys of the input unit, in a current display state of the output unit;
step (3) of performing a second allocation process of press key sequence, when detecting a command to change the object to be targeted by the input-focus in response to a press of the identified press key of the input unit by the user after the first allocation process of press key sequence has been performed, said step (3) including
performing an input-focus movement process, that is, identifying from the storage unit the object id associated with the press key sequence identical to the identified press key, and moving the input-focus to the object indicated by the identified object id,
performing a deletion process of press key sequence, that is, deleting association of the press key sequence with the object id whose head does not include the identified press key pressed by the user under a change command, and with the object id associated with the press key sequence identical to the identified press key pressed by the user under the change command, wherein the association is deleted from pieces of association between the press key sequence and the object id stored in the storage unit,
performing an updating allocation process of press key sequence, said updating allocation process of press key sequence including
identifying from the storage unit all the press key sequence whose head includes the identified press key pressed by the user under the change command and which is constituted by combining the at least two identified press keys of the input unit, and
for each identified press key sequence, identifying the object id associated with said each press key sequence, and deleting association therebetween from the storage unit, and deleting from said each press key sequence the identified press key pressed by the user included in a head of said each press key sequence, thereby obtaining a new press key sequence and associating the new press key sequence with the object id having the association deleted therefrom, and storing an associated result in the storage unit, and
performing an allocation process of press key sequence, for the object id of the object having no input-focus and not associated with press key sequence stored in the storage unit, out of the plurality of objects displayed on the view area of output unit, said allocation process of press key sequence including
calculating a second position relation between a second reference position of the output unit and the object view range associated with the object id stored in the storage unit,
identifying association between the allocation priority for press key sequence and the press key sequence, on the basis of the calculated second positional relation, for the object id from the storage unit, and
associating the identified press key sequence with the object id and storing an associated result in the storage unit, and
performing the image-display process of press key sequence of said step (2), thereby notifying the user of the operation-support computer system of a new press-key sequential relation; and
step (4) of performing each process of said step (3), when detecting a command to change the object to be targeted by the input-focus in response to a press of the identified press key of the input unit by the user after the second allocation process of press key sequence has been performed.

2. An operation-support computer program executed on a computer system including a storage unit configured to store information, a processing unit configured to process information, an output unit configured to output information to a user, and an input unit configured to receive a command from the user, whereby a plurality of objects are displayed on a view area of the output unit and the user is allowed to control through the input unit an object having an input-focus out of the plurality of objects, the operation-support computer program configured to cause the processing unit to execute steps thereof,
the operation-support computer program comprising:
step (1) of performing a first allocation process of press key sequence, for the object identified by an object id stored in the storage unit out of the plurality of objects displayed on the view area of the output unit, wherein the storage unit is further configured to store the object id identifying the object, and an object view range indicative of a position/size of the object on the view area of the output unit, both of which are associated with each other, and store a press key sequence indicative of an identified press key of the input unit or a combination of at least two identified press keys of the input unit, and an allocation priority for press key sequence to the object id, both of which are associated with each other, and store the press key sequence, and an image of press key sequence that is an image indicative of the identified press key sequence of the input unit or a combination of the at least two identified press keys of the input unit, both of which are associated with each other, said step (1) including
calculating a first positional relation between a first reference position of the output unit and the object view range associated with the object id stored in the storage unit,
identifying association between the allocation priority for press key sequence and the press key sequence, on the basis of the calculated first positional relation, and
associating the identified press key sequence with the object id and storing an associated result in the storage unit, for the object id stored in the storage unit;
step (2) of performing an image-display process of press key sequence, for the object id stored in the storage unit, based on association between the press key sequence and the object id stored in the storage unit, and based on association between the press key sequence and the image of press key sequence stored in the storage unit, said step (2) including
identifying the press key sequence associated with the object id stored in the storage unit, and identifying the image of press key sequence associated with the identified press key sequence, and
displaying the identified image of press key sequence with reference to a view range of the output unit based on the object view range associated with the objet id, thereby notifying the user of the computer system of a press-key sequential relation as to the object to be reached by the input-focus in response to a press of the identified press key of the input unit or a combined and consecutive press of the at least two identified press keys of the input unit, in a current display state of the output unit;
step (3) of performing a second allocation process of press key sequence, when detecting a command to change the object to be targeted by the input-focus in response to a press of the identified press key of the input unit by the user after the first allocation process of press key sequence has been performed, said step (3) including
performing an input-focus movement process, that is, identifying from the storage unit the object id associated with the press key sequence identical to the identified press key, and moving the input-focus to the object indicated by the identified object id,
performing an updating allocation process of press key sequence so as to renew association between the press key sequence obtained after updating process and the object id into the latest association between the press key sequence and the object id, out of pieces of association between the press key sequence and the object id stored in the storage unit, said updating allocation process of press key sequence including
identifying from the storage unit all the press key sequence whose head includes the identified press key pressed by the user under the change command and which is constituted by combining the at least two identified press keys of the input unit, and
for each identified press key sequence, deleting from said each press key sequence the identified press key pressed by the user included in a head of said each press key sequence thereby obtaining a new press key sequence, associating the new press key sequence with the object id associated with said each identified press key sequence, and storing an associated result in the storage unit in a separate manner, and
performing an allocation process of press key sequence, for the object id of the object having no input-focus and not associated with press key sequence stored in the storage unit, out of the plurality of objects displayed on the view area of output unit, said allocation process of press key sequence including
calculating a second position relation between a second reference position of the output unit and the object view range associated with the object id stored in the storage unit,
identifying association between the allocation priority for press key sequence and the press key sequence, on the basis of the calculated second positional relation, for the object id from the storage unit, and
associating the identified press key sequence with the object id and storing an associated result in the storage unit, and
performing the image-display process of press key sequence of said step (2), thereby notifying the user of the operation-support computer system of a new press-key sequential relation;
step (4) of performing each process of said step (3), when detecting a command to change the object to be targeted by the input-focus in response to a press of the identified press key of the input unit by the user after the second allocation process of press key sequence has been performed; and
step (5) of rendering the association between press key sequence and the object id, which has been obtained one-generation before the updating allocation process of press key sequence of said step (3), to be the latest association between the press key sequence and the object id, and moving the input-focus to the object having the input-focus before the input-focus movement process of said step (3), when detecting a return command of press key sequence in response to a press of the identified press key of the input unit pressed by the user, after the second allocation process of press key sequence has been performed.

3. The operation-support computer program according to claim 1, wherein
in the first allocation process of press key sequence, the first reference position of the output unit is determined with reference to the view area of an object having an input-focus, a mouse cursor, or an input cursor, which are displayed on the view area of the output unit, and
in the second allocation process of press key sequence, the second reference position of the output unit is determined with reference to the view area of an object having an input-focus displayed on the view area of the output unit.

4. The operation-support computer program according to claim 1, wherein
in the first allocation process of press key sequence, the first reference position of the output unit is determined, with reference to the view area of an object having the highest priority, on the view area of the output unit on which the object indicated by the object id targeted by the first allocation process of press key sequence is displayed, out of objects displayed on the view area of the output unit, that is, an object having an input-focus, a mouse cursor, an input cursor, and an object to which the allocation process of press key sequence has already been applied, and
in the allocation process of press key sequence of a combination of the at least two identified press keys, the first allocation process of press key sequence is performed in a manner that, for an object id with reference to which the first positional relation is in the highest priority out of the plurality of object ids with reference to which the same first reference position is determined:
the allocation process of press key sequence is performed by associating between the object id and the identified press key sequence, which is obtained by adding one press key to the press key sequence allocated to the object of the first reference position, and which is the highest in allocation priority for press key sequence and is not yet allocated to any object, from the storage unit; and
the allocation process of press key sequence is repeated by adding objects subjected to the allocation process of press key sequence to the first reference position until a first termination condition is satisfied, and wherein
in the second allocation process of press key sequence, the second reference position of the output unit is determined, with reference to the view area of an object having the highest priority, on the view area of the output unit on which the object indicated by the object id targeted by the second allocation process of press key sequence is displayed, out of an object having an input-focus and an object to which the allocation process of press key sequence has already been applied, and
in the allocation process of press key sequence of a combination of the at least two identified press keys, the second allocation process of press key sequence is performed in a manner that, for an object id with reference to which the second positional relation is in the highest priority out of the plurality of object ids with reference to which the same second reference position is determined:
the allocation process of press key sequence is performed by associating between the object id and the identified press key sequence, which is obtained by adding one press key to the press key sequence allocated to the object of the second reference position, and which is the highest in allocation priority for press key sequence and is not yet allocated to any object, from the storage unit; and
the allocation process of press key sequence is repeated by adding objects subjected to the allocation process of press key sequence to the second reference position until a second termination condition is satisfied.

5. The operation-support computer program according to claim 1, wherein
in the first allocation process of press key sequence, the first reference position of the output unit is determined, with reference to the view area of the output unit, that is, an object having an input-focus, a mouse cursor, an input cursor, and an object to which the allocation process of press key sequence has already been applied, and the first positional relation is calculated on the basis of a combination of the first reference position and the object id stored in the storage unit, and
in the allocation process of press key sequence of a combination of the at least two identified press keys, the allocation process of press key sequence is performed for the first reference position in a manner that:
the allocation process of press key sequence is performed by identifying the press key sequence, which is obtained by adding one press key to the press key sequence allocated to the object of the first reference position, and which is the highest in allocation priority for press key sequence and is not yet allocated to any object, from the storage unit; and
the allocation process of press key sequence is repeated by determining a new first reference position with reference to the view area of the object subjected to the allocation process of press key sequence in the immediately preceding allocation process of press key sequence until a first termination condition is satisfied, and wherein
in the second allocation process of press key sequence, the second reference position of the output unit is determined, with reference to the view area of an object on the view area of the output unit already subjected to the allocation process of press key sequence and an object having an input-focus, and
in the allocation process of press key sequence of a combination of the at least two identified press keys, the allocation process of press key sequence is performed for the second reference position in a manner that:
the allocation process of press key sequence is performed by identifying the press key sequence, which is obtained by adding one press key to the press key sequence allocated to the object of the second reference position, and which is the highest in allocation priority for press key sequence and is not yet allocated to any object, from the storage unit; and
the allocation process of press key sequence is repeated by determining a new second reference position with reference to the view area of the object subjected to the allocation process of press key sequence in the immediately preceding allocation process of press key sequence until a second termination condition is satisfied.

6. The operation-support computer program according to claim 5, wherein
in the image-display process of press key sequence,
when the identified object id is associated with the plurality of press key sequences stored in the storage unit, the press key sequence with the highest in allocation priority is identified out of the plurality of press key sequences on the basis of allocation priority for the associated press key sequences stored in the storage unit, and the image of press key sequence associated with the identified press key sequence is displayed on the output unit.

7. The operation-support computer program according to claim 1, wherein
the storage unit is further configured to store the press key sequence indicative of the identified press key of the input unit or a combination of the at least two identified press keys of the input unit, and an allocation priority for the press key sequence to the objects id, both of which are associated with each other in accordance with an allocation priority rule defining priorities among the identified press keys of the input unit, and store the identified press key id of the input unit and the allocation priority indicative of allocation priority among the press keys in the input unit, both of which are associated with each other, and wherein
a creation process of press key sequence is performed by associating the allocation priority for press key sequence and the press key sequence, and storing the association between the allocation priority for press key sequence and the press key sequence in the storage unit, in accordance with the association between the allocation priority for press key sequence and the press key id as the allocation priority rule defining priorities among the identified press keys of the input unit, whereby the association between the allocation priority for press key sequence and the press key sequence stored in the storage unit are created.

8. The operation-support computer program according to claim 3, wherein
when either of the first reference position of the output unit at the first allocation process of key sequence or the view area of the output unit of the object indicated by the object id stored in the storage unit is changed, after the first allocation process of key sequence has been performed, and
when either of the second reference position of the output unit at the second allocation process of key sequence or the view area of the output unit of the object indicated by the object id stored in the storage unit is changed, after the second allocation process of key sequence has been performed,
the processing unit performs again the first allocation process of press key sequence of said step (1).

9. The operation-support computer program according to claim 1, wherein
when a command to reallocate the press key sequence is detected in response to a press of key targeting the reallocation process of press key sequence of the input unit by the user, after the first allocation process of key sequence has been performed, and
when a command to reallocate the press key sequence is detected in response to a press of key targeting the reallocation process of press key sequence of the input unit by the user, after the second allocation process of key sequence has been performed
the processing unit performs again the first allocation process of press key sequence of said step (1).

10. The operation-support computer program according to claim 1, wherein
the storage unit is further configured to store the association between the press key sequence and the object id, that is, information about a fixed press key sequence object, and wherein
the association between the press key sequence and the object id with respect to the fixed press key sequence object is not subjected to each process of said step (1) and said step (3) other than the input-focus movement process performed by the processing unit, and the allocation process of the fixed press key sequence object is performed by moving an input-focus to the identified object in response to a press of the identified press key of the input unit or a combined and consecutive press of the at least two identified press keys of the input unit.

11. The operation-support computer program according to claim 1, wherein
the allocation process of press key sequence, by which the press key sequence and the object id are associated with each other and an associated result is stored in the storage unit, is performed for only one press key sequence and only one object id, in the first allocation process of press key sequence of said step (1) and in the second allocation process of press key sequence of said step (3) performed by the processing unit.

12. A operation-support computer system comprising: the storage unit configured to store each information and the operation-support computer program of claim 1; the processing unit configured to perform each process of claim 1; an output unit configured to output information to a user; and an input unit configured to receive a command from the user.

13. The operation-support computer program according to claim 2, wherein
in the first allocation process of press key sequence, the first reference position of the output unit is determined with reference to the view area of an object having an input-focus, a mouse cursor, or an input cursor, which are displayed on the view area of the output unit, and
in the second allocation process of press key sequence, the second reference position of the output unit is determined with reference to the view area of an object having an input-focus displayed on the view area of the output unit.

14. The operation-support computer program according to claim 2, wherein
in the first allocation process of press key sequence, the first reference position of the output unit is determined, with reference to the view area of an object having the highest priority, on the view area of the output unit on which the object indicated by the object id targeted by the first allocation process of press key sequence is displayed, out of objects displayed on the view area of the output unit, that is, an object having an input-focus, a mouse cursor, an input cursor, and an object to which the allocation process of press key sequence has already been applied, and
in the allocation process of press key sequence of a combination of the at least two identified press keys, the first allocation process of press key sequence is performed in a manner that, for an object id with reference to which the first positional relation is in the highest priority out of the plurality of object ids with reference to which the same first reference position is determined:
the allocation process of press key sequence is performed by associating between the object id and the identified press key sequence, which is obtained by adding one press key to the press key sequence allocated to the object of the first reference position, and which is the highest in allocation priority for press key sequence and is not yet allocated to any object, from the storage unit; and
the allocation process of press key sequence is repeated by adding objects subjected to the allocation process of press key sequence to the first reference position until a first termination condition is satisfied, and wherein
in the second allocation process of press key sequence, the second reference position of the output unit is determined, with reference to the view area of an object having the highest priority, on the view area of the output unit on which the object indicated by the object id targeted by the second allocation process of press key sequence is displayed, out of an object having an input-focus and an object to which the allocation process of press key sequence has already been applied, and
in the allocation process of press key sequence of a combination of the at least two identified press keys, the second allocation process of press key sequence is performed in a manner that, for an object id with reference to which the second positional relation is in the highest priority out of the plurality of object ids with reference to which the same second reference position is determined:
the allocation process of press key sequence is performed by associating between the object id and the identified press key sequence, which is obtained by adding one press key to the press key sequence allocated to the object of the second reference position, and which is the highest in allocation priority for press key sequence and is not yet allocated to any object, from the storage unit; and
the allocation process of press key sequence is repeated by adding objects subjected to the allocation process of press key sequence to the second reference position until a second termination condition is satisfied.

15. The operation-support computer program according to claim 2, wherein
in the first allocation process of press key sequence, the first reference position of the output unit is determined, with reference to the view area of the output unit, that is, an object having an input-focus, a mouse cursor, an input cursor, and an object to which the allocation process of press key sequence has already been applied, and the first positional relation is calculated on the basis of a combination of the first reference position and the object id stored in the storage unit, and
in the allocation process of press key sequence of a combination of the at least two identified press keys, the allocation process of press key sequence is performed for the first reference position in a manner that:
the allocation process of press key sequence is performed by identifying the press key sequence, which is obtained by adding one press key to the press key sequence allocated to the object of the first reference position, and which is the highest in allocation priority for press key sequence and is not yet allocated to any object, from the storage unit; and
the allocation process of press key sequence is repeated by determining a new first reference position with reference to the view area of the object subjected to the allocation process of press key sequence in the immediately preceding allocation process of press key sequence until a first termination condition is satisfied, and wherein
in the second allocation process of press key sequence, the second reference position of the output unit is determined, with reference to the view area of an object on the view area of the output unit already subjected to the allocation process of press key sequence and an object having an input-focus, and
in the allocation process of press key sequence of a combination of the at least two identified press keys, the allocation process of press key sequence is performed for the second reference position in a manner that:
the allocation process of press key sequence is performed by identifying the press key sequence, which is obtained by adding one press key to the press key sequence allocated to the object of the second reference position, and which is the highest in allocation priority for press key sequence and is not yet allocated to any object, from the storage unit; and
the allocation process of press key sequence is repeated by determining a new second reference position with reference to the view area of the object subjected to the allocation process of press key sequence in the immediately preceding allocation process of press key sequence until a second termination condition is satisfied.

16. The operation-support computer program according to claim 15, wherein
in the image-display process of press key sequence,
when the identified object id is associated with the plurality of press key sequences stored in the storage unit, the press key sequence with the highest in allocation priority is identified out of the plurality of press key sequences on the basis of allocation priority for the associated press key sequences stored in the storage unit, and the image of press key sequence associated with the identified press key sequence is displayed on the output unit.

17. The operation-support computer program according to claim 2, wherein
the storage unit is further configured to store the press key sequence indicative of the identified press key of the input unit or a combination of the at least two identified press keys of the input unit, and an allocation priority for the press key sequence to the objects id, both of which are associated with each other in accordance with an allocation priority rule defining priorities among the identified press keys of the input unit, and store the identified press key id of the input unit and the allocation priority indicative of allocation priority among the press keys in the input unit, both of which are associated with each other, and wherein
a creation process of press key sequence is performed by associating the allocation priority for press key sequence and the press key sequence, and storing the association between the allocation priority for press key sequence and the press key sequence in the storage unit, in accordance with the association between the allocation priority for press key sequence and the press key id as the allocation priority rule defining priorities among the identified press keys of the input unit, whereby the association between the allocation priority for press key sequence and the press key sequence stored in the storage unit are created.

18. The operation-support computer program according to claim 13, wherein
when either of the first reference position of the output unit at the first allocation process of key sequence or the view area of the output unit of the object indicated by the object id stored in the storage unit is changed, after the first allocation process of key sequence has been performed, and
when either of the second reference position of the output unit at the second allocation process of key sequence or the view area of the output unit of the object indicated by the object id stored in the storage unit is changed, after the second allocation process of key sequence has been performed,
the processing unit performs again the first allocation process of press key sequence of said step (1).

19. The operation-support computer program according to claim 2, wherein
when a command to reallocate the press key sequence is detected in response to a press of key targeting the reallocation process of press key sequence of the input unit by the user, after the first allocation process of key sequence has been performed, and
when a command to reallocate the press key sequence is detected in response to a press of key targeting the reallocation process of press key sequence of the input unit by the user, after the second allocation process of key sequence has been performed
the processing unit performs again the first allocation process of press key sequence of said step (1).

20. The operation-support computer program according to claim 2, wherein
the storage unit is further configured to store the association between the press key sequence and the object id, that is, information about a fixed press key sequence object, and
wherein the association between the press key sequence and the object id with respect to the fixed press key sequence object is not subjected to each process of said step (1) and said step (3) other than the input-focus movement process performed by the processing unit, and the allocation process of the fixed press key sequence object is performed by moving an input-focus to the identified object in response to a press of the identified press key of the input unit or a combined and consecutive press of the at least two identified press keys of the input unit.
